(19) United States
(12) Patent Application Publication
(10) Pub. No.: US 2026/0253284 A1
(43) Pub. Date: Aug. 27, 2026

(54) Systems and methods for generating designs

(71) Applicant: Canva Pty Ltd, Surry Hills (AU)

(72) Inventors: Xavier O’Rourke, Cairns (AU); Raz Friman, Woronora Heights (AU)

(73) Assignee: Canva Pty Ltd, Surry Hills (AU)

(21) Appl. No.: 19/286,550

(22) Filed: Jul. 31, 2025

(30) Foreign Application Priority Data
Feb. 24, 2025 (AU) 2025201305

(51) Int. Cl. G06T 11/60; G06T 11/00; G06T 11/40

(52) U.S. Cl. CPC G06T 11/60; G06T 11/10; G06T 11/40; G06T 2200/24; G06T 2210/62

(57) ABSTRACT

Described herein is a computer implemented method. The method includes receiving, via one or more user input devices, a design request that includes design description that describes a design. The design request is processed to generate an action generation prompt and a set of output actions is generated by processing the action generation prompt using a first trained machine learning model. A new design is generated based on the set of output actions, and generating the new design includes processing the set of output actions to generate a corresponding set of design elements and including the set of design elements in the new design.

### CROSS REFERENCE TO RELATED APPLICATION

This application is a U.S. Non-Provisional Application that claims priority to Australian Patent Application No. 2025201305, filed Feb. 24, 2025, which is hereby incorporated by reference in its entirety.

### TECHNICAL FIELD

The present disclosure is directed to systems and methods for generating designs.

### BACKGROUND

Computer applications for creating and working with designs exist.

Certain design applications allow users to create designs that are made up of individual design elements. For example, a user may select one or more design elements and add them to a design. Design elements of various types may be provided, such as images, icons, text, and/or other types of design elements.

Once elements have been added to a design a user can edit the design by manipulating the elements that have been added—e.g. changing element sizes, positions, depths, colours, and/or other relevant element attributes.

### SUMMARY

Described herein is a computer implemented method including: receiving, via one or more user input devices, a design request, wherein the design request includes a description that describes a design; processing, by one or more processing devices, the design request to generate an action generation prompt, wherein the action generation prompt includes a first prompt component that is based on the design request, a second prompt component that includes instructions to generate a set of actions, and a third prompt component that describes action schemas for one or more different types of action that are available; generating a set of output actions by processing the action generation prompt using a first trained machine learning model; and generating a new design based on the set of output actions, wherein generating the new design includes: processing the set of output actions to generate a corresponding set of design elements; and including the set of design elements in the new design.

### BRIEF DESCRIPTION OF THE DRAWINGS

In the drawings:

FIG. 1 depicts an example design.

FIG. 2 is a block diagram of a networked environment in which embodiments of the present disclosure may be performed.

FIG. 3 is a block diagram of a computer processing system.

FIG. 4 depicts an example graphical user interface.

FIG. 5 is a flowchart depicting operations performed to automatically generate a design.

FIG. 6 is a flowchart depicting operations performed to automatically generate a design.

FIG. 7 is a flowchart depicting operations performed to generate an icon.

FIG. 8 depicts multiple versions of a design as elements are automatically generated and added to it.

FIG. 9 is a flowchart depicting operations performed to generate an icon.

FIG. 10 depicts an example graphical user interface.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present disclosure.

### DETAILED DESCRIPTION

In the following description numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

As discussed above, computer applications for use in creating and working with designs exist. In the context of the present disclosure, a design is a digital design that is made up of (or includes) a set of one or more design elements (referred to as elements for convenience). Each element of a design is associated with various element properties which define the actual content of the element (e.g. a raster image, a vector graphic, text, video, or other content) and how that content is displayed (e.g. size, position, opacity, rotation, and/or or other display properties). Further, each element of a design can be edited independently to other elements of the design.

A design of the present disclosure may be contrasted, for example, with a raster image—i.e. an image that is defined by a set of pixels. While certain pixel-level operations can be performed on a raster image, a raster image does not include independently editable elements as described above.

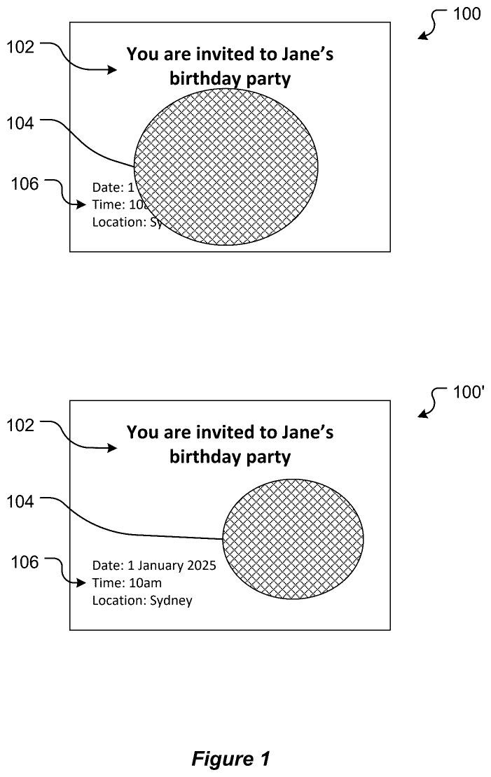

To illustrate this, FIG. 1 depicts an example design 100 for a birthday invitation. Design 100 includes three elements: element 102 which includes the text “you are invited to Jane's birthday party”; element 104 which includes an image (in this case a simple circle); and element 106 which includes text in respect of a date, time, and location.

In design 100, element 104 has been positioned so that it overlaps (in the x/y plane) element 106 and has a depth that is above element 106. Consequently, the image of element 104 partially occludes the text of element 106. To address this occlusion, a user may edit design 100 by manipulating element 104 and/or 106. Various operations to do this may be possible—for example a user may: resize and/or reposition element 104 so that it no longer overlaps with element 106 (in the x/y plane); change the depth order of elements 104 and 106 so element 104 is behind element 106; edit element 104 so it is transparent or partially transparent and element 106 can be seen through it. FIG. 1 depicts an amended version 100′ of design 100 in which element 104 has been resized and repositioned and longer overlaps element 106.

In contrast, if design 100 was a raster image it would not be possible to manipulate the pixels corresponding to elements 104 and 106 to address the occlusion. Even if individual pixels were manipulated recovery of text beneath image element 104 in design 100 would not be possible.

Certain embodiments of the present disclosure are directed to systems and methods for automatically generating designs based on a short, textual design description. In accordance with these embodiments, a user may, for example provide a design description such as “a design for a bake sale”. In response, a design for a bake sale (including a set of independently editable design elements) is automatically generated.

Other embodiments of the present disclosure are directed to systems and methods for generating digital icons.

In the present disclosure, a design is defined by design data.

Design data is data that can be processed by a relevant application (for example a client application such as 232 described below or an alternative application) to render and display a design and/or perform other design operations (as one example exporting or converting the design to another data format, such as a pdf document/raster image/alternatively formatted electronic record that corresponds to the design).

The particular data that is required (or can optionally be) included in a valid design dataset, and the format of that data, is defined by what will be referred to as a design schema. In this disclosure, reference to a design, or to a design dataset, is reference to a dataset that accords with a design schema.

In the embodiments described herein, a design dataset includes (or is associated with) a set of design properties. These properties are used to define design level data and content data.

Design level data includes data relevant to the design as a whole. One example of design level data is design size—e.g. a width and height of the design. Design level data may also include design metadata, such as a design identifier (uniquely identifying the design) and/or other metadata.

In the embodiments described herein, the content data of a design is defined by a set of one or more element datasets (also referred to elements for convenience). An element dataset is used to define actual content that has been added to a design (for example a raster image, a vector graphic, text content, video content, and/or other content) any other data that defines how that content is displayed in the design (for example position data, size data, rotation data, opacity data, or other data).

The particular data that is required (or can optionally be) included in a valid element dataset, and the format of that data, is defined by an element schema (which in this case is part of the design schema). Reference to an element dataset (or an element), therefore, is reference to a dataset that accords with an element schema.

Any appropriate design schema may be used to define the format of design datasets (and element datasets). As one example, a design schema that provides for design datasets such as the following may be used (noting that this is a partial and simplified design dataset that is provided for illustrative purposes only):

| | |
|---|---|
| { | |
| “designID”: string, | //unique identifier of design |
| “dimensions”: {″width″: number, ″height″: number}, | //dimensions of design (in pixels) |
| ... | |
| “elements”: [{element record 1}, ..., {element record n}] | //array of at least one element record |
| } | |

In this example, a design dataset is an object that includes a set of key-value pairs (also referred to as properties).

In this example, the design schema allows for a designID property and a dimensions property. The designID property stores a value that provides a unique identifier for the design. The dimensions property is a compound property that includes a width property (that takes a value indicating a width of the design) and a height property (that takes a value indicating a width of the design). While not shown, the design schema may allow for (or require) additional and/or alternative design level data to be defined for a design. For example, properties may be provided to require or allow data such as the following to be defined for a design: a design version identifier; a design creation date; a user identifier (identifying the creator or owner of the design); permissions data (defining users that can access the design and what permissions those users have); access history data (defining users that have accessed the design and when); and/or other data.

In this example, the design schema provides for design content to be defined in an ordered set (in this case an array) of element datasets. An element dataset is used to define each content item that has been added to a design. In this example, the position of an element dataset in the elements array serves both to identify that element and define its depth (or z-index). For example, an element at array index n is positioned above an element at array index n−1 and below an element at array index n+1. Element depth is relevant where non-transparent elements (or non-transparent portions of elements) overlap one another in the x/y plane. Element depth may be alternatively handled, however, for example, by storing depth as an explicit element property.

As will be appreciated, the data that is required (or can optionally be used) to define one type of content item that is added to a design may be different to the data that is required (or can optionally be used) to define a different type of content item that is added to a design. For example, text format attributes may be relevant to an element in respect of text content that is added to a design but not be relevant to an element in respect of a raster image that is added to a design. In the present example, therefore, the design schema defines different element schemas. Each element schema is associated with a different type of content and defines properties that are relevant to that type of content.

The actual element schemas provided, and their specific properties, will depend on the types of content that are supported by the design platform and on implementation. In order to illustrate the features of the present disclosure, simplified (and partial) element schemas for two different types of elements are provided below: a rectangle-type element and a text-type element.

An example rectangle element schema is as follows:

```
{
“elementType”: “rectangle”;
“position”: {“x”: number, “y”: number, “w”: number, “h”: number},
“rotation”: number,
“opacity”: number,
“borderRadiusPercent”: number,
“borderColour”: string,
“borderWeightPx”: number,
  “fill″: {
    “type”: “colour”,
    “colour”: string
  } | {
    “type”: ″gradient”,
    “stops”: [{“colour”: string, “opacity”: number}],
    “angle”: number
  } | {
    “type”: “image”,
    “imageID”: string
}
}
```

In this example, a rectangle-type element includes:
An element type property which takes a value of “rectangle”.
A position property which is used to define an element's position and size. In this example, the position property is a compound property that includes the following sub-properties: a position.x property (used to define an element's x-coordinate); a position.y property (used to define an element's x-coordinate); a position.w property (used to define an element's width); and a position.h property (used to define an element's height). In the present examples, a Cartesian coordinate system is used in which the origin of a page (i.e. x=y, y=0) is at the top-left: i.e. x coordinates increase from left to right, and y coordinates increase from top to bottom. In this coordinate system, the (x,y) coordinates of an element's position define the top left corner of the element prior to any rotation that may be associated with/applied to the element.
A rotation property which is used to define a rotation of the element—e.g. a number between 0 and 360 degrees (inclusive).
An opacity property which is used to define an opacity (or transparency) of the element—e.g. a number between 0 (indicating fully transparent) and 1 (indicating fully opaque).
A border radius property which is used to define one or more border radius values (e.g. as one or more percentage values that define the radius/radii of one or more of the four corners of the rectangle).
A border colour property which is used to define a colour (e.g. as a hex-format colour string) of the rectangle's border.
A border weight property which is used to define a number indicating a weight of the rectangle's border (e.g. in pixels).
A “fill” property that is used to define the actual fill content of the rectangle type element. In this example, the fill property is a compound property and allows one of three different types of fills to be defined: a colour (e.g. a solid colour), a gradient (e.g. a colour gradient), or an image (e.g. a raster image).
   For a colour fill, a “colour” sub-property is used to define a colour of the fill (e.g. as a string indicating a hex-format colour value).
   For a “gradient” fill, a “stops” sub-property is used to define a set of at least two colour stops (e.g. by hex colour strings) and, optionally, an opacity value for each colour stop (e.g. a number between 0 and 1 (default 1/opaque)). In addition, an “angle” sub-property is used to define an angle of the gradient fill (e.g. a number between −180 and 180 that indicates the gradient angle in degrees, with 0 degrees indicating to-bottom, 180 degrees indicating to-top, 90 indicating to-right, −90 degrees indicating to-left).
   For an “image” fill, an “imageID” property is provided that is used to identify (and or determine a storage location of) the actual fill the rectangle type element is to be used to display.

An example text element schema is as follows:

```
{
  “elementType”: “text”,
  “position”: {“x”: number, “y”: number, “w”: number, “h”: number},
  “rotation”: number,
  “opacity”: number,
  “content″: string,
  “fontName”: string,
  “textColour”: string,
  “italic”: boolean,
  “bold”: boolean,
  “effect″: {
    “type”: “shadow”,
    “colour”: string,
    “blur”: number,
    “offset”: number,
    “opacity”: number
  } | {
    “type”: ″<text effect type 2>”,
    “<effect property 1>”: ...,
    ...,
    “<effect property n>”: ...
  },
}
```

In this example, a text-type element includes:
An element type property which takes a value of “text”.
Position, rotation, opacity, border radius, border colour, and border weight properties which are as described for the example rectangle type element above.
A “content” property that is used to define the actual text content of the element (e.g. the characters).
Several format proprieties (in this example, and for illustrative purposes, font name, text colour, italic, and bold properties) that are used to define various format properties of the text. Alternative format properties may be provided (and/or text formatting may be defined in different ways).
An “effect” property that is used to define an effect applied to the text. In this example, two effects are possible-a “shadow” effect (in which case a shadow angle, offset, and colour are defined) or a “text effect type 2” effect (an alternative text effect with associated properties).

It will be appreciated that the “rectangle” and “text” element schemas above are provided by way of example only. A design platform will typically provide for additional types of content to be included in a design. Furthermore, additional and/or alternative properties may be used to define a given type of content that is added to a design (and how that content is included in the design).

In the present example, a background element for a design is defined by the element dataset that is at index 0 of the design's elements array. For example, a rectangle-type element at array index 0 may define a design background that is a solid colour, a colour gradient, or an image. In this case an element that is the design background element will typically have a position of (0,0) and width and height that are the same as the width and height of the design itself. In alternative implementations, however, a design's background may be defined in other ways. For example, a design's background may be defined by a specific “background” property (or set of properties) that is separate from (in this case) the set of design elements.

The example design schema above provides for designs that are a single-page. In alternative implementations, however, a design schema that provides for multi-page designs may be used. In this case, and for example, the design schema may allow a set of pages to be defined (e.g. by an array of page records), with each page then associated with its own content data (e.g. its own ordered set of element records that define content items that have been added to that page).

Embodiments of the present disclosure are directed to automatically generating designs. These embodiments involve generating what are referred to as element generation actions (also referred to as actions for convenience).

In the present disclosure, an action is a dataset that is processed by a relevant application (e.g. design generation application 220 as discussed below or an alternative application) to generate a design element.

In the present disclosure, different types of actions are defined. Each different type of action is defined by what will be referred to as an action schema. Each action schema defines an action type and the particular data (and data formatting) that is required for (or can optionally be included in) an action of that type. Reference to an element generation action (or action), therefore, is reference to a dataset that accords with a particular action schema.

Action schemas are designed to be used with a specific design schema. More specifically, the action schemas are designed so that a particular action generated in accordance with a particular action schema can be used by a relevant application to generate a particular design element in accordance with the specific design schema.

In light of this, the particular action schemas that are defined will depend on implementation. Generally speaking, each action schema will correspond to an element type that is supported by a design data schema (and it is possible for multiple action schemas to correspond to the same type of element). It is not, however, necessary to provide action schemas corresponding to every different type of element supported by the design schema. For example, a design schema may provide an element schema for audio type elements (i.e. elements used to include audio content in a design) but this does not necessitate the provision of a corresponding “generate audio” type action schema (for generating actions that can be used to generate audio-type elements). Further, an action schema that corresponds to a particular element type does not need to provide properties that correspond to every element property defined by the design schema for that element type. For example, a rectangle-type element schema may include a rotation parameter that allows an element rotation to be defined for rectangle-type elements, but this does not necessitate that a corresponding rectangle-type action schema (which can be used to define an action that is used to generate rectangle-type elements) must include a property that allows a rotation to be specified. Still further, an action schema may include a property that corresponds to an element property but that does not directly define a value for that element property. Examples of this are the “imagePrompt” and “iconPrompt” properties discussed below.

In order to illustrate the features of the present disclosure, four example action schemas are described below: a rectangle action schema, an icon action schema, a text action schema, and a background action schema.

The following provides an example of a rectangle action schema. In the present embodiments, and with reference to the example design schema described above, a rectangle action (i.e. an action that accords with the rectangle action schema) is processed by an appropriate application (e.g. the design generation application 220 described below) to generate a rectangle-type design element.

```
{
  “actionType”: “rectangle”,
  “position”: “x:{number},y:{number},w:{number},h:{number}”,
  “fill”: {
    “type”: “colour”,
    “colour”: string,
    “opacity”: number
  } | {
    “type”: “gradient”,
    “stops”: [{“colour”: string, “opacity?”: number}],
    “angle”: number
  } | {
    “type”: “image”,
    “imagePrompt”: string
  },
  “borderRadiusPercent?”: number,
  “borderColour?”: string,
  “borderWeightPx?”: number
}
```

The rectangle action schema of this example includes position, fill, border radius, border colour, and border weight properties that correspond to the properties of the example rectangle-type element described above. As can be seen, the rectangle action schema does not include properties that correspond to all available rectangle element properties (for example, a rectangle-type element includes a rotation property but in this particular example the rectangle action schema does not include a rotation property).

In this example, the rectangle action schema provides an image prompt property for an “image” type fill. This differs to a rectangle type element which has an “imageID” property (which is used to identify a specific and existing image) for an image fill. As described further below, when an action that defines an image prompt is processed the image prompt is used to generate (or otherwise acquire) an image that is then included (or identified) in an element.

To further illustrate the example rectangle action schema, the following provides examples of a rectangle action (i.e. an action generated in accordance with the example rectangle action schema) and an example design element that is generated based on that rectangle action:

```
{
  ″actionType″:″rectangle″,
  ″position″:“x:40, y:40, w:1000, h:1000”,
  ″fill″:{″type″:″colour″,″colour″:″#FFFFFF″,″opacity″:0.85},
  ″borderRadiusPercent″:5
}
```

### Example Rectangle Action

```
{
  “elementType”: “rectangle”,
  “position”: {“x”:40, “y”: 40, “w”: 1000, “h”: 1000},
  “rotation”: 0,
  “opacity”: 0.85,
  “borderRadiusPercent”: 5,
  “borderColour”: “#000000”,
  “borderWeightPx”: 0,
  “fill″: {
    “type”: “colour”,
    “colour”: “#FFFFFF”}
}
```

### Example Rectangle Element Generated Based on Example Rectangle Action

To further illustrate actions, the following provides an example of an icon action schema. In the present embodiments, and with reference to the example design schema described above, an icon action (i.e. an action that accords with the icon action schema) can be processed to generate a rectangle-type design element that has an image that is an icon as a fill. Icons are discussed in detail below. In the present embodiments, even though icons and images are both raster images, they are distinguished from one another because they are used in designs in different ways.

```
{
  “actionType”: “icon”,
  “position”: “x:{number},y:{number},w:{number},h:{number}”,
  “iconPrompt”: string,
  “colour”: string
}
```

### Example Icon Action Schema

The icon action schema of this example includes position, icon prompt, and colour properties. As described in detail below, values of the icon prompt and colour properties of an icon action are, in due course, used to generate (or otherwise acquire) an icon.

To further illustrate the example icon action schema, the following provides examples of an icon action (i.e. an action generated in accordance with the example icon action schema) and an example design element that is generated based on that icon action:

```
{
  ″actionType″:″icon″,
  ″position″:“x:80, y:80, w:100, h:100”,
  ″iconPrompt″: “a cupcake icon”,
  ″colour″:″#FFFFFF″,
  }
```

### Example Icon Action

```
{
  “elementType”: “rectangle”,
  “position”: {“x”:80, “y”: 80, “w”: 100, “h”: 100},
  “rotation”: 0,
  “opacity”: 1,
  “borderRadiusPercent”: 0,
  “borderColour”: “#000000”,
  “borderWeightPx”: 0,
  “fill″: {
    “type”: “image”,
    “imageID”: “<ID of image that generated/otherwise acquired based on the iconPrompt>”}
}
```

### Example Rectangle Element Generated Based on Example Icon Action

To further illustrate actions, the following provides an example of a text action schema. In the present embodiments, and with reference to the example design schema described above, a text action (i.e. an action that accords with the text action schema) can be processed to generate a text-type design element.

```
{
  “actionType”: “text”,
  ″position″: ″x:{number},y:{number},w:{number},h:{number}″,
  “content″: string,
  “fontName”: string,
  “textColour”: string,
  “italic?”: boolean,
  “bold?”: boolean,
  “effect?”: {
    “type”: “shadow”,
    “colour”: string,
    “blur”: number,
    “offset”: number,
    “opacity”: number,
  } | {
    “type”: “<text effect type 2>”,
    “<effect property 1>”: ...,
    ...,
      “<effect property n>”: ...
  },
}
```

### Example Text Action Schema

The text action schema of this example includes position, content, font name, text colour, alignment, style, and effect properties that correspond to the properties of the example text-type element described above.

To further illustrate the example text action schema, the following provides examples of a text action (i.e. an action generated in accordance with the example text action schema) and an example design element that is generated based on that text action:

```
{
  “actionType”: “text”,
  “position”: “x:240, y:520, w:600, h:120”,
  “content”: “BAKE SALE”,
  “fontName”: “Abril Fatface”,
  “textColour”: “#FF69B4”,
  “effect”:{
    “type”: “shadow”,
    “colour”: “#FFFFFF”,
    “blur”: 0.5,
    “offset”: 1,
    “opacity”: 1
  }
}
```

### Example Text Action

```
{
  “elementType”: “text”,
  “position”: {“x”: 240, “y”: 520, “w”: 600, “h”: 120},
  “rotation”:0,
  “opacity”: 1,
  “content″: “BAKE SALE”,
  “fontName”: “Abril Fatface”,
  “textColour”: “#FF69B4”,
  “italic”: false,
  “bold”: false,
  “effect″: {
    “type”: “shadow”,
    “colour”: “#FFFFFF”,
    “blur”: 0.5,
    “offset”: 1,
    “opacity”: 1
  }
}
```

### Example Text Element Generated Based on Example Text Action

To further illustrate actions, the following provides an example of a background action schema. In the present embodiments, and with reference to the example design schema described above, a background action (i.e. an action that accords with the background action schema) can be processed by an appropriate application to generate a rectangle-type design element that is used as a design background.

```
{
  “actionType”: “background”,
  “fill”: {
  “type”: “colour”,
  “colour”: string,
  “opacity”: number
  } | {
  “type”: “gradient”,
  “stops”: [{“colour”: string, “opacity?”: number}],
  “angle”: number
  } | {
  “type”: “image”,
  “imagePrompt”: string
  },
}
```

### Example Background Action Schema

As can be seen, the background action schema of this example is similar to the rectangle action schema described above except does not include position, border radius, border colour, or border weight properties.

To further illustrate the example background action schema, the following provides examples of a background action (i.e. an action generated in accordance with the example background action schema) and an example design background. In the present example, which relies on the example design schema described above, the design background is a rectangle-type design element that is recorded at index 0 of a design's elements array (and in this particular example a design size of 1080×1080 pixels-leading to an element height and width of 1080—is used):

```
{
  “actionType”:“background”,
  “fill”:{“type”:“image”,“imagePrompt”:“a pink and white pattern”
}
```

### Example Background Action

```
{
  “elementType”: “rectangle”;
  “position”: {“x”:0, “y”: 0, “w”: 1080, “h”: 1080},
  “rotation”: 0,
  “opacity”: 1,
  “borderRadiusPercent”: 0,
  “borderColour”: #000000,
  “borderWeightPx”: 0,
  “fill″: {
    “type”: “image”,
    “imageID”: “<ID of image generated/otherwise acquired based on the imagePrompt>”}
}
```

### Example Rectangle Element Generated Based on Example Background Action

The above action schemas and their properties are described by way of example only. The specific action schemas (and their properties) that are defined will depend on various implementation details. These include, for example, the specific types of design elements that the design schema permits and the properties available (or required) to define attributes of those elements. For example, if the design schema permits video type elements (i.e. elements that are associated with/used to include video content in a design), a video action schema may be provided. Similarly, if the design schema permits audio type elements (i.e. elements that are associated with/used to include audio content in a design), a video action schema may be provided.

Certain actions in the examples above can include an “image prompt” (which, in due course, is used to generate or otherwise acquire an image). In certain implementations, action prompts may include other types of prompts that are used to generate other types of content or media items. For example, where a design schema supports video content one or more action schemas may include a videoPrompt (which, in due course, is used to generate or otherwise acquire a video content item that is then included (or identified) in an appropriate design element. As another example, where a design schema supports audio content one or more action schemas may include an audioPrompt (which, in due course, is used to generate or otherwise acquire an audio content item that is then included (or identified) in an appropriate design element. With this in mind, prompts that are used to generate or otherwise acquire content may be referred to as content prompts.

In certain implementations, the design generation application 220 is implemented as (or to include) application programming interface (API). That is, application 220 provides an API endpoint that other applications can send API requests to. In these embodiments, the API is associated with an API schema and the action schemas define API request formats for the API—i.e. the format of API requests that application 220 can receive and process to generate design elements (and, in the present embodiments, add those design elements to a design).

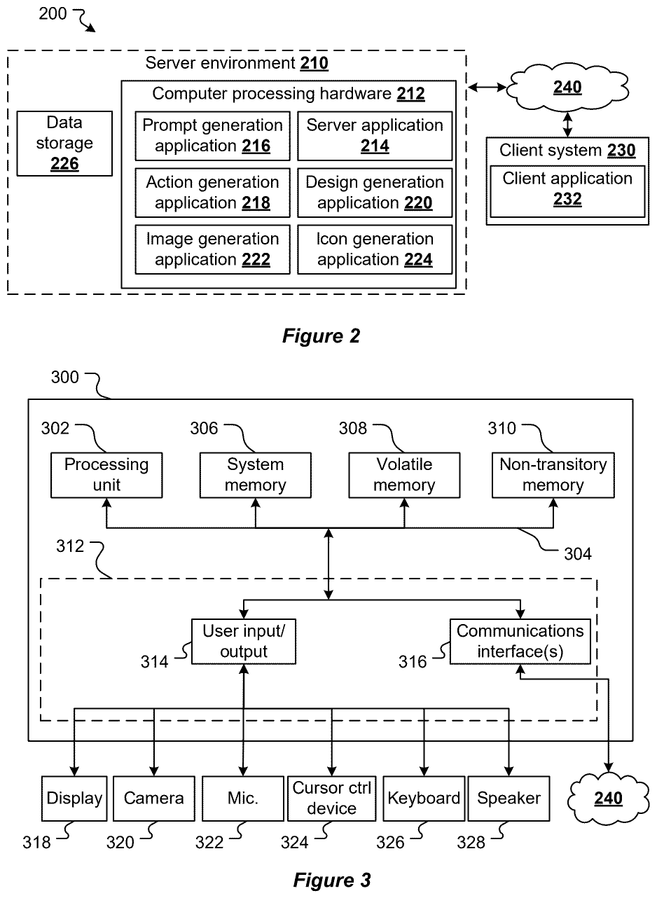

The features of the present disclosure are described in the context of a design platform. In the described embodiments, this platform includes server-side and client-side applications which operate to perform the various techniques described. One example of such a platform will be described with reference to networked environment 200 of FIG. 2.

Networked environment 200 includes a server environment 210 and a client system 230 which communicate via one or more communications networks 240 (e.g. the Internet).

Generally speaking, the server environment 210 includes computer processing hardware 212 (discussed below) on which one or more applications that provide server-side functionality to client applications (such as client application 232 described below) execute.

In the present example, server environment 210 includes a server application 214 which executes to (inter alia) provide a client application endpoint that is accessible over communications network 240. For example, where server application 214 serves web browser client applications the server application 214 will be a web server which receives and responds (for example) to HTTP requests. Where server application 214 serves native client applications, server application 214 will be an application server configured to receive, process, and respond to specifically defined API requests received from those client applications. The server environment 210 may include one or more web server applications and/or one or more application server applications allowing it to interact with both web and native client applications.

In the present example, server application 214 (and or other applications of server environment 210) facilitate various functions related to creating and editing designs. This may include, for example, design creation, editing, storage, searching, retrieval, publication, and viewing. The server application 214 (and/or other applications) may also facilitate additional functions that are typical of server systems—for example user account creation and management, user authentication, and/or other server side functions.

In the present example, server application 214 also coordinates processing performed by other server-side applications that include a prompt generation application 216, an action generation application 218, a design generation application 220, an image generation application 222, and an icon generation application 224. The functions performed by these applications are described in detail below.

Server environment 210 also includes one or more data storage applications (not shown) which operate to receive and process requests to persistently store and to retrieve data that is relevant to the operations performed by the server environment 210. Such requests may be received from the server application 214, other server environment applications, and/or (in some instances) directly from client applications such as 232. Data relevant to the operations performed/services provided by the server environment 210 may include, for example, user account data, design data (e.g. design records defining designs that have been created), media data (e.g. data in respect of stock media items such as images and/or other media items that can be added to designs), and/or other data relevant to the operation of the server environment 210. The data storage application(s) may, for example, include a relational database management application or an alternative application for storing and retrieving data from data storage 226.

Data storage 226 may be any appropriate data storage device (or set of devices), for example one or more non transitory computer readable storage devices such as hard disks, solid state drives, tape drives, or alternative computer readable storage devices.

As noted, the server environment 210 applications run on (or are executed by) computer processing hardware 212. Computer processing hardware 212 includes one or more computer processing systems. The precise number and nature of those systems will depend on the architecture of the server environment 210.

For example, in one implementation each server environment application may run on its own dedicated computer processing system. In another implementation, two or more server environment applications may run on a common/shared computer processing system. In a further implementation, server environment 210 is a scalable environment in which application instances (and the computer processing hardware 212—i.e. the specific computer processing systems required to run those instances) are commissioned and decommissioned according to demand—e.g. in a public or private cloud-type system. In this case, server environment 210 may simultaneously run multiple instances of each application (on one or multiple computer processing systems) as required by client demand.

Communication between the applications and computer processing systems of the server environment 210 may be by any appropriate means, for example direct communication or networked communication over one or more local area networks, wide area networks, and/or public networks (with a secure logical overlay, such as a VPN, if required).

Client system 230 hosts a client application 232 which, when executed by the client system 230, configures the client system 232 to provide client-side functionality, which will typically include interacting with server environment 210 (or, more specifically, the server application 214 and/or other applications provided by the server environment 210). Via the client application 232, and as discussed in detail below, a user can access the various functionality described herein.

The client application 232 may be a general web browser application which accesses the server application 214 via an appropriate uniform resource locator (URL) and communicates with the server application 214 via general world-wide-web protocols (e.g. http, https, ftp). Alternatively, the client application 232 may be a native application programmed to communicate with server application 214 using defined application programming interface (API) requests and responses.

In the environment of FIG. 1, and the embodiments described below, processing is described as being performed by different applications. In most cases, however, processing that is described as being performed by one particular application could be performed by one or more alternative client- or server-side applications. As one example, the techniques described herein may be provided as part of a stand-alone system with all processing and data storage performed by a single computer processing system (which is configured by one or more applications to do so).

As noted, the techniques and operations described herein are performed by one or more computer processing systems.

By way of example, client system 230 may be any computer processing system which is configured (or configurable) by hardware and/or software—e.g. client application 232—to offer client-side functionality. A client system 230 may be a desktop computer, laptop computer, tablet computing device, mobile/smart phone, or other appropriate computer processing system.

Similarly, the applications of server environment 210 are executed by one or more computer processing systems. Server environment computer processing systems will typically be server systems, though again may be any appropriate computer processing systems.

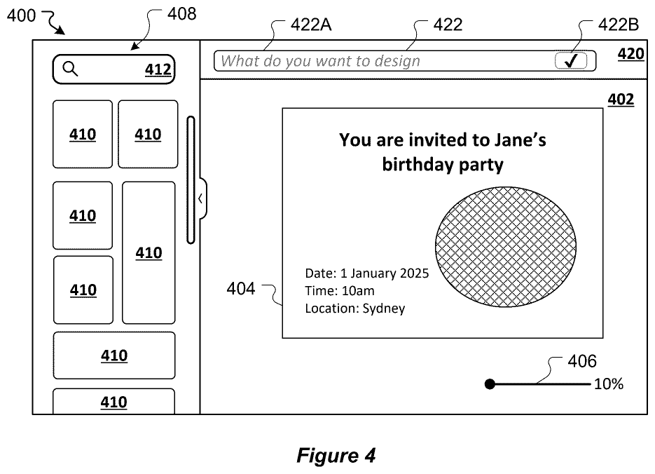

FIG. 3 provides a block diagram of a computer processing system 300 configurable to implement embodiments and/or features described herein. System 300 is a general purpose computer processing system. It will be appreciated that FIG. 3 does not illustrate all functional or physical components of a computer processing system. For example, no power supply or power supply interface has been depicted, however system 300 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 300 includes at least one processing unit 302. The processing unit 302 may be a single computer processing device (e.g. a central processing unit, graphics processing unit, or other computational device), or may include a plurality of computer processing devices. In some instances, where a computer processing system 300 is described as performing an operation or function all processing required to perform that operation or function will be performed by processing unit 302. In other instances, processing required to perform that operation or function may also be performed by remote processing devices accessible to and useable (either in a shared or dedicated manner) by system 300.

Through a communications bus 304 the processing unit 302 is in data communication with a one or more machine readable storage (memory) devices which store computer readable instructions and/or data which are executed by the processing unit 302 to control operation of the processing system 300. In this example system 300 includes a system memory 306 (e.g. a BIOS), volatile memory 308 (e.g. random access memory such as one or more DRAM modules), and non-transitory memory 310 (e.g. one or more hard disk or solid state drives).

System 300 also includes one or more interfaces, indicated generally by 312, via which system 300 interfaces with various devices and/or networks. Generally speaking, other devices may be integral with system 300, or may be separate. Where a device is separate from system 300, connection between the device and system 300 may be via wired or wireless hardware and communication protocols, and may be a direct or an indirect (e.g. networked) connection.

Generally speaking, and depending on the particular system in question, devices to which system 300 connects—whether by wired or wireless means—include one or more input devices to allow data to be input into/received by system 300 and one or more output devices to allow data to be output by system 300. Example devices are described below, however it will be appreciated that not all computer processing systems will include all mentioned devices, and that additional and alternative devices to those mentioned may well be used.

For example, system 300 may include or connect to one or more input devices by which information/data is input into (received by) system 300. Such input devices may include keyboard, mouse, trackpad, microphone, accelerometer, proximity sensor, GPS, and/or other input devices. System 300 may also include or connect to one or more output devices controlled by system 300 to output information. Such output devices may include devices such as a display (e.g. a LCD, LED, touch screen, or other display device), speaker, vibration module, LEDs/other lights, and/or other output devices. System 300 may also include or connect to devices which may act as both input and output devices, for example memory devices (hard drives, solid state drives, disk drives, and/or other memory devices) which system 300 can read data from and/or write data to, and touch screen displays which can both display (output) data and receive touch signals (input).

By way of example, where system 300 is a client system such as 230 it may include a display device 318 (which may be a touch screen display), a camera device 320, a microphone device 322 (which may be integrated with the camera device), a cursor control device 324 (e.g. a mouse, trackpad, or other cursor control device), a keyboard 326, and a speaker device 328.

System 300 also includes one or more communications interfaces 316 for communication with a network, such as network 240 of environment 200 (and/or a local network within the server environment 210). Via the communications interface(s) 316, system 300 can communicate data to and receive data from networked systems and/or devices.

System 300 may be any suitable computer processing system, for example, a server computer system, a desktop computer, a laptop computer, a netbook computer, a tablet computing device, a mobile/smart phone, a personal digital assistant, or an alternative computer processing system.

System 300 stores or has access to computer applications (also referred to as software or programs)—i.e. computer readable instructions and data which, when executed by the processing unit 302, configure system 300 to receive, process, and output data. Instructions and data can be stored on non-transitory machine readable medium such as 310 accessible to system 300. Instructions and data may be transmitted to/received by system 300 via a data signal in a transmission channel enabled (for example) by a wired or wireless network connection over an interface such as communications interface 316.

Typically, one application accessible to system 300 will be an operating system application. In addition, system 300 will store or have access to applications which, when executed by the processing unit 302, configure system 300 to perform various computer-implemented processing operations described herein. For example, and referring to the networked environment of FIG. 2 above, server environment 210 includes one or more systems which run a server application 214, a prompt generation application 216, an action generation application 218, a design generation application 220, an image generation application 222, and an icon generation application 224. Similarly, client system 230 runs a client application 232.

In the present disclosure, client application 232 configures the client system 230 to display (on a display device such as device 318) a user interface (UI). Generally speaking, the UI allows a user to create, edit, and output designs.

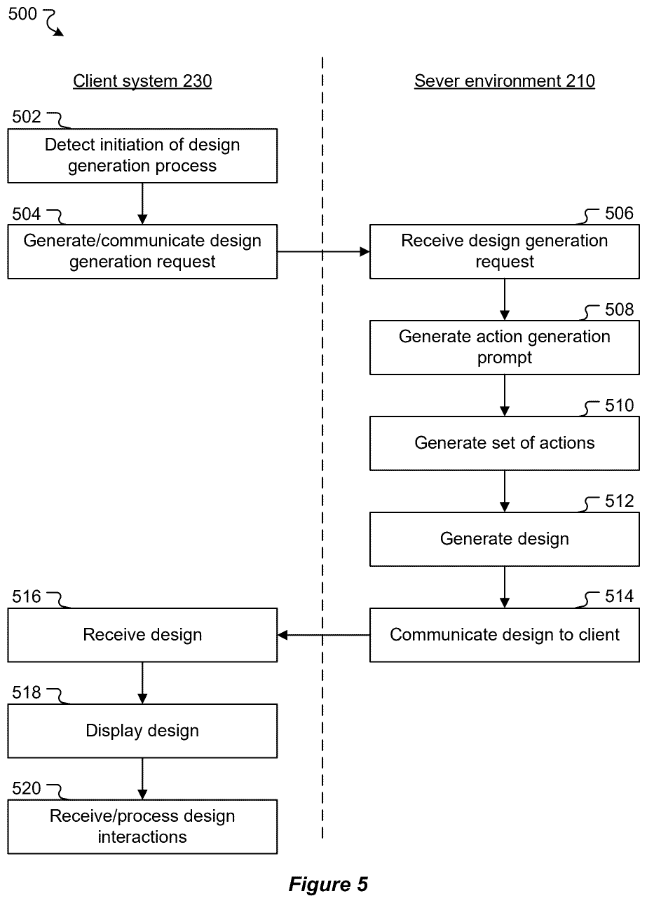

To illustrate the types of features that client application 232 may provide, FIG. 4 provides an example UI 400. UI 400 includes a preview area 402 which is used to display a design 404. A zoom control 406 is provided allowing user input to zoom into and out of the design 404 that is displayed.

UI 400 also includes an asset preview area 408. Asset preview area 408 displays previews 410 of assets that are available to users to assist in creating a design. Asset preview area 410 includes a search control 412 via which a user can submit search data (e.g. a string of characters) to search for particular assets. Previews 410 of the search results returned are then displayed in the asset preview area 408.

Depending on implementation, the previews 410 displayed in asset preview area 408 (and the assets corresponding to those previews) may be accessed from various locations. For example, the search functionality invoked by search control 412 may cause client application 232 to search for assets that are stored in locally accessible memory of the system 230 on which client application 232 executes (e.g. non-transitory memory such as 310 or other locally accessible memory), assets that are stored at a remote server (and accessed via a server application running thereon), and/or assets stored on other locally or remotely accessible devices.

Different types of assets may be made available, for example media items such as images, design templates, design styles (e.g. defined sets of colours, font types, and/or other assets/asset parameters), and/or other assets that a user may use when creating a design. For example, a preview 410 may be of a media item (e.g. a raster image, a vector graphic, a video, or an alternative media item) and a user may add that media item to the design 404 being edited by dragging and dropping the preview 410 onto the design 404.

Content may be added to a design in other ways. For example, content may be drawn or otherwise created using one or more design tools (e.g. a text tool, a line tool, a rectangle tool, an ellipse tool, a curve tool, a freehand tool, and/or other design tools). Content may also be copied or imported from other designs, electronic documents, or libraries (e.g. libraries of images, animations, videos, etc.).

GUI 400 also includes an additional controls area 420 which is used to display additional controls. The additional controls may include permanent controls (e.g. controls such as save, download, print, share, publish, and/or other controls that are frequently used/widely applicable and that client application 232 is configured to permanently display); user configurable controls (which a user can select to add to or remove from area 420), and/or adaptive controls (which may automatically change depending, for example, on the type of content that is currently selected/being interacted with by a user). For example, if text content of the design 404 is currently selected, adaptive controls such as font style, type, size, and/or other font related controls may be displayed. Alternatively, if vector graphic content is selected, adaptive controls such as fill attributes, line attributes, transparency, and/or other vector graphic related controls may be displayed.

In the present example, UI 400 includes a generate design control 422 which, in this particular example, includes a text entry field 422A (that a user can enter text into) and a submit control 422B (that a user can activate to submit text entered into the text entry field 422A). As described further below, the generate design control 422 allows a user to provide a design generation input and trigger automatic generation of a design based on that input.

Once a design has been generated, application 232 may provide various options for outputting that design. For example, application 232 may provide a user with one or more options such as: saving the design to local memory of client system 230 (e.g. non-transitory memory 310); saving the design to data storage 226 of server environment 210; printing the design to a printer (local or networked); communicating the design to another user (e.g. by email, instant message, or other electronic communication channel); publishing the design to a social media platform or other service (e.g. by sending the design data to a third party server system using appropriate API requests to publish the design); and/or by other output means.

It will be appreciated that UI 400 is provided by way of example only. Alternative user interfaces, that have alternative layouts and/or provide alternative tools and functions, are possible.

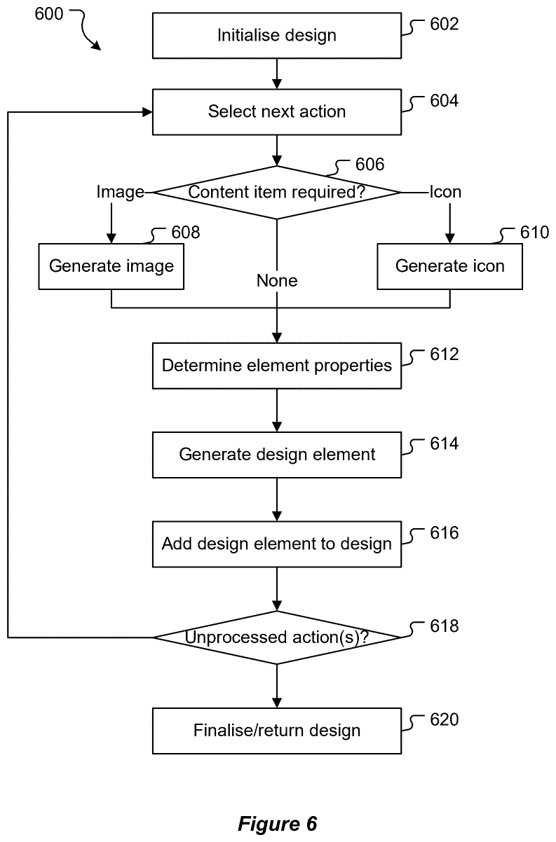

As noted above, certain embodiments of the present disclosure are directed to systems and methods for automatically generating designs. Referring to FIG. 5, a computer implemented method 500 for doing so will be described.

In method 500, various processing is performed by (or at) either client system 230 or server environment 210. In method 500, the server-side processing is coordinated by server application 214 (which causes other server-side applications to perform various operations). In alternative embodiments, however, the processing of method 500 could be coordinated and/or performed by one or more alternative applications.

At 502, client application 232 detects initiation of a design generation process. Initiation of the design generation process is associated with a design request that includes a description of a design that the system is being instructed to generate.

The design generation process may be initiated in various ways. By way of example, the design generation process may be initiated in response to receiving one or more user inputs at client application 232. This may be user input(s) via a UI control such as control 422 described above. For example, a user may specify a design request by entering text into the text input field 422A and then submit that text (either via a particular key—such as an enter key—or activation of the submit control 422B). Client system 230 may facilitate entry of a design request string in additional (or alternative) ways, for example by capturing user speech via a microphone (such as 322). Such speech input may be to a text string (and that text string may, though need not, be displayed in a text input field such as 422A).

At 504, in response to detecting initiation of the design generation process, client application 232 generates a design generation request and communicates this to the server environment 210 (in this example to server application 214). The design generation request includes the design request.

At 506, server application 214 receives the design generation request.

At 508, an action generation prompt is generated. In the present embodiment, server application 214 communicates the design request to the prompt generation application 216 to generate the action generation prompt. In alternative embodiments, however, the action generation prompt could be generated by the server application 214 itself (or an alternative application).

The action generation prompt generated at 508 is a text string that will (in due course-see 510) be processed by a trained machine learning model. Generally speaking, the action generation prompt includes instructions to generate a set of actions based on the design request and instructions that each action in the set of actions is to be generated in accordance with an available action schema.

To achieve this, the prompt generation application 216 is configured to generate a prompt that is composed of several prompt components (or components for short).

In the present embodiments, the prompt components include an instruction component that describes the task that is to be performed. The instruction component includes several sub-components: a task component, a design size component, and an output component.

The task component is based on the design request and generally indicates the task that is to be performed. For example, for a design request of “a social media post for a bake sale”, application 216 may be configured to generate a task component such as:

You are creating a design for a social media post for a bake sale.

The design size component indicates the size of the design that is to be generated. By way of example, the design size component may be text such as:

The design has a width of 1080 pixels and a height of 1080 pixels.

A size for the design that is to be generated may be determined in alternative ways. In the present embodiment, the prompt generation application 216 is configured to process the design request to determine whether it includes text that allows a design size to be determined. To this end, application 216 has access to size reference data (e.g. a lookup table or other data) that associates different design types (or design type keywords) with design dimensions (width×height). For example, the size reference data may include associations such as: [(“Instagram”: 1080×1080; “x”: 1200×675; “Facebook”: 1200×630; “poster”: 2480×3508; . . . )]. In this case, if application 216 determines that the design request refers to a known design type (e.g. by inclusion of known design type keyword) it determines the size of the design based on that type/keyword. If the design request does not include a known design type/keyword, a default/predetermined design size is used (e.g. 1080×1080 or an alternative design size).

In alternative embodiments, one or more UI controls may be provided by which a user can specify a design size. E.g. UI 400 may include design size controls such as a width input control and a height input control, and/or UI elements that allow a user to select a design type from a set of common design types (with each design type being associated with a design size). In this case, if a user specifies a design size (or a type of design with an associated design size) the client application 232 communicates this to the server application 214 (e.g. at 504) which, in turn, communicates or makes the size data available to the prompt generation application 216. If no size is specified (and no size can be determined based on the design request), a predetermined size design size is used.

In further alternative embodiments, design size controls are not provided and application 216 is configured to use a predetermined design size regardless of the design request (e.g. all automatically generated designs have a same size such as of 1080×1080 pixels).

The output component describes the output that is to be generated. In the present disclosure, a design is generated based on a set of actions (as described above). Accordingly, an output component such as the following may be used:
In order to create the design you have an API available for adding elements to the design. You are to return a valid JSONL file that does not include anything except an ordered set of actions, with each action on a new line. The design starts off blank and each action will result in an element being added to the design in depth order from back to front.

In the present embodiments, the prompt components also include an available actions component. The available actions component includes a set of available action subcomponents. Each available action subcomponent describes a specific action that is available to generate a design (the available actions being actions defined by action schemas as described above). In this example, each available action subcomponent includes action schema text (describing the action schema itself—i.e. the data and format required for a valid action). Each available action subcomponent may also include one or more action usage components which provide information on how the action schema can or is to be used (and/or how a particular property of the action schema can or is to be used). To illustrate this, an example available actions component corresponding to the example action schemas described above is as follows:

The actions that are available via the API and their properties are as follows:

```
<available_actions>
{
  ″actionType″: ″rectangle″,
  ″position″: ″x:{number},y:{number},w:{number},h:{number}″,
  ″fill″: {
    ″type″: ″colour″,
    ″colour″: string, // hex colour string
    ″opacity″: number // 0 for transparent, 1 for opaque
  } | {
    ″type″: ″gradient″,
    ″stops″: [{″colour″: string, ″opacity?″: number}], //an array of at least two colour stops
                                            // with hex colours and optional opacity
                                            // values (default value 1)
    ″angle″: number // a gradient angle between −180 and +180 degrees
  } | {
    ″type″: ″image″,
    ″imagePrompt″: string // will be used to generate an image
  },
  ″borderRadiusPercent?″: number, //optional, default 0
  ″borderColour?″: string, //optional, hex colour string, default #000000
  ″borderWeightPx?″: number //optional, border width in pixels, default 0
}
{
  ″actionType″: ″icon″,
  ″position″: ″x:{number},y:{number},w:{number},h:{number}″,
  ″iconPrompt″: string, //will be used to generate an icon
  ″colour″: string //hex colour string
}
{
  “actionType”: “text”,
  “position”: “x:{number},y:{number},w:{number},h:{number}”,
  “content″: string,
  “fontName”: string, //fonts available include Abril Fatface, Poppins, Montserrat, ...
  “textColour”: string, //hex colour string
  “effect?”: { //optional text effect
    “type”: “shadow”,
    “colour”: string, //hex colour string
    “blur”: number, // a positive number specifying a blur radius
    “offset”: number, // a number between 0 and 360 specifying the shadow offset
    “opacity”: number, // 0 for transparent, 1 for opaque
  } | {
    “type”: “<text effect type 2>”,
    “<effect property 1>”: ...,
    ...,
    “<effect property n>”: ...
  },
}
{
  ″actionType″: ″background″, // used to define a design background
  ″fill″: {
  ″type″: ″colour″,
  ″colour″: string, //a hex colour string
  ″opacity″: number // 0 for transparent, 1 for opaque
  } | {
  ″type″: ″gradient″,
  ″stops″: [{″colour″: string, ″opacity?″: number}], //an array of at least two colour stops
                                          // with hex colours and optional opacity
                                          // values (default value 1)
  ″angle″: number // a gradient angle between −180 and +180 degrees
  } | {
  ″type″: ″image″,
  ″imagePrompt″: string // used to generate an image
  },
}
</available_actions>
```

In this example, action usage components are provided in the form of comments preceded by “//” characters. For example, the action usage components included for the “imagePrompt” and “iconPrompt” properties state that the prompt will be used to generate an image or icon. In embodiments where the image or icon prompt is used to search for and select an existing image or icon, the action usage notes are changed to reflect this. As another example, the action usage component included for the “borderColour?” property indicates both that use of the property is optional and that if a value is not specified (or the property is not used) a particular default value will apply. As a further example, the action usage component for the “fontName” property provides a list of names of fonts that are available to be used.

In the present embodiments, the prompt components also include a design guidance component. The design guidance component includes one or more subcomponents, each of which provides guidance on generating a design. An example design guidance component is:

Please take the following into account:
Always ensure good text contrast, taking into account that you do not know exactly what image an image prompt will result in.
Take care to avoid unintended collisions (e.g. when one element overlaps another).

The actual design guidance subcomponents will depend on implementation. Furthermore, in certain embodiments application 216 may be configured to include different design guidance subcomponents depending on the type of design that is being generated. For example, if application 216 determines that the design being generated is first type of design (e.g. an Instagram post, determined, for example, by processing the design request as described above) it may include a first set of design guidance subcomponents in the prompt (e.g. an “Instagram” set of guidance subcomponents that are appropriate to an Instagram post design), but if application 216 determines that the design being generated is a second type of design (e.g. a poster) it may include a second set of design guidance subcomponents in the prompt. In this case, the first and second sets of design guidance subcomponents will be different (though they may share one or more specific subcomponents).

In certain implementations, prompt generation application 216 may be configured to generate a prompt that includes one or more worked examples. In this case, each worked example will include an example task (that will describe an example task that is different to the actual task) and an example output corresponding to that task (e.g. a set of actions that would suitably be generated based on the example task). Including one or more worked examples can be useful to provide yet further guidance as to the type of output that is desired.

Prompt generation application 216 may be configured to generate a prompt with additional (and/or alternative) prompt components to those described above, or with only a subset of the prompt components described above. Further, a prompt may include one or more prompt components that are designed to provide the same or similar information as described above but do so via alternative wording.

At 510, the action generation prompt generated at 508 is processed to generate a set of one or more actions. In the present embodiment, the action generation prompt is communicated to and processed by the action generation application 218 to do this. This may involve the prompt generation application 216 communicating the prompt directly to the action generation application 218. Alternatively, the prompt generation application 216 may communicate the prompt to the server application 214 which then communicates with the action generation application 218.

Action generation application 218 is, or makes use of, a trained machine learning model (which may be referred to as a first trained machine learning model). In particular, the action generation application 218 is (or makes use of) a trained language model.

In certain embodiments, the trained language model is a large language model (LLM). For example, the trained language model may be a LLM such as Anthropic Claude 3.5 Sonnet (or an alternative Claude LLM), OpenAI GPT-40, OpenAI GPT-01 (or an alternative GPT model), Amazon Nova Pro, Google Gemini Flash 2.0, Meta Llama 3.3 70B, or an alternative LLM.

In other embodiments, the trained language model is a specialised language model (SLM) that has been developed and trained specifically to generate actions (according to the relevant action schemas) that are then used to generate designs.

Due to the way the action generation prompt is generated, the output generated by the action generation application 218 will be text (e.g. a JSONL file in the example above) that defines one or more actions in accordance with the defined action schemas.

At 512, the set of actions generated at 510 is processed to generate a new design.

In the present embodiments, size data that defines (or permits determination of) design dimensions is also used to generate the design. The size data is the same as (or based on) the design size included in the design size component of the design generation prompt that was used to generate the set of actions (described above). For example, if the size component of the design generation prompt indicated a design size of 1080×1080, then the size data that is used to generate the design allows for these dimensions (i.e. a design width of 1080 and a design height of 1080) to be determined.

In the present embodiment, the set of actions and size data are communicated (or made available) to and processed by the design generation application 220 to generate the new design. This may involve the action generation application 218 communicating the set of actions and size data directly to the design generation application 220. Alternatively, the action generation application 218 may communicate the set of actions and size data to the server application 214 which then communicates with the design generation application 220.

In other embodiments, for example embodiments in which a default design size is provided in the action generation prompt, communicating size data to the design generation application 220 may not be necessary (as application 220 can be configured to generate designs of the default size).

In certain embodiments, the set of actions is communicated to the design generation application 220 in one or more API requests.

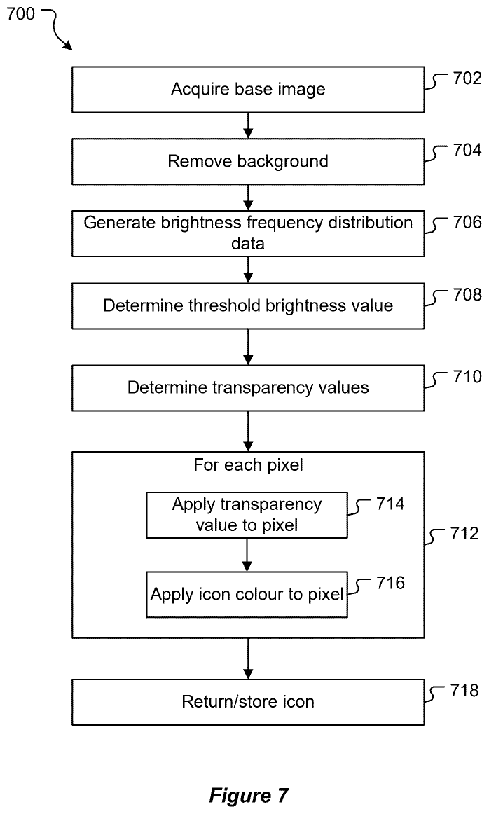

Generation of a design based on a set of actions is described in detail below with reference to FIG. 6. Generally speaking, however, design elements are generated (each element in the set of design elements corresponding to an action in the set of actions) and included in a new design.

At 514, the design generated at 512 is communicated to the client system 230 (e.g. to client application 232). In the present embodiment, the design generation application 220 communicates the design to the server application 214 which then communicates the design to the client application 232.

At 516, client application 232 receives the design.

At 518, client application 232 displays the design on a display device 318 of the client system 230. For example, client application 232 may display the design in a preview area of a user interface (such as preview area 402 of UI 400 described above).

Once the design is displayed, and as generally indicated at 520, a user may interact with the design in various ways that client application 232 (and the design platform as a whole) facilitates. By way of example, a user may (via a UI such as UI 400 described above): save the design (causing the design to be written to a non-transitory memory device of the client system 230 such as memory 310, data storage 226 of the server environment 210, and/or other local or remote memory devices); publish the design to a social media or other publication service; share the design (e.g. via email, instant message, or other electronic communication channel); print the design (e.g. to a local or remote printer); export or convert the design to a different format (e.g. to a raster image format, a pdf format, or an alternative electronic document format) and save/share/publish the exported design; and/or otherwise interact with the design.

As the design has been generated in accordance with the design platform's design schema, a user can also interact with the design by editing the design as they would any other design created using the design platform. This may, for example, involve: deleting one or more of the design elements that were generated for the design; editing one or more of the design elements that were generated for the design, e.g. by (depending on the editing functions provided and the type of element) editing size, editing x and/or y position, editing depth (e.g. by sending backwards/bringing forwards), editing colour (e.g. by one or more colour filters or other colour editing options), editing opacity, editing rotation, and/or performing other editing operations; adding one or more new elements to the design (e.g. by searching for an asset using a search control such as 412 and then dragging an asset preview 410 onto the design as displayed).

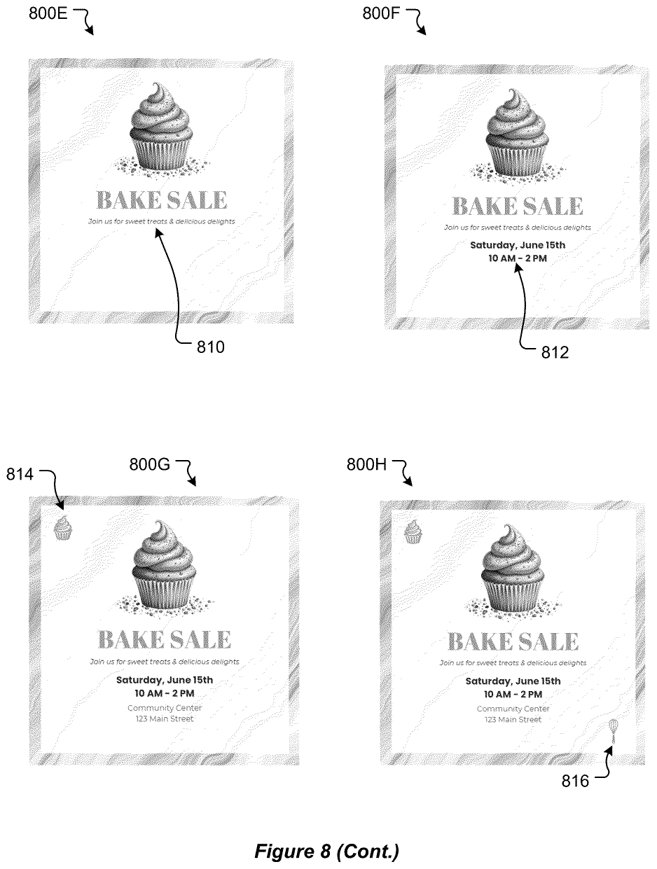

In method 500, an entire design is generated by the design generation application 220 before being communicated to and displayed by the client application 232. In alternative embodiments, design elements may be generated (by design generation application 220 or an alternative application) and provided to the client application on a one-by-one basis. This allows the client application to display different versions of the design as it is generated—e.g. by progressively adding the elements that are generated to the design. An example of this is the different design versions depicted in FIG. 8 and described below.

In method 500, automatic design generation includes (inter alia) use of a trained machine learning model to generate a set of actions. Those actions are then processed to generate a corresponding set of design elements. An advantage of this approach is that if the underlying design platform evolves to support a new type of design element (for example video elements) incorporating that new type of design element in the automatic design generation process is reasonably straight forward. In particular, the capability of generating a new type of element can be added to method 500 by: defining an appropriate action schema for the new type of element; adjusting the available actions component of the prompt to reference the new action schema; and configuring the design generation application 220 to process the new type of action to generate an element of the new type.

Turning to FIG. 6, a method 600 for generating a new design based on a set of actions and size data will be described. Method 600 may be performed at processing block 512 of method 500.

The processing of method 600 is described as being performed by the design generation application 220 (referred to as application 220 in this section). In alternative embodiments, however, the processing of method 600 could be performed by one or more alternative applications. As one example, the server application 214 could be configured to perform the processing of method 600. As another example, the client application 232 could be configured to perform the processing of method 600.

Method 600 is performed based on a set of one or more actions and size data. Application 220 may receive or access the set of actions in various ways. For example, application 220 may receive the set of actions (and size data) in an API request (or a series of API requests) made by another application (e.g. server application 214 or action generation application 218). Alternatively, application 220 may be provided with a reference to a file (e.g. a text file) that includes the set of actions and size data.

In certain embodiments, application 220 may be configured to automatically generate new designs of a predefined (default) size. In this case, method 600 does not take size data as an input.

At 602, application 220 initialises a new design. The precise operations performed to do this will depend on how designs are defined by the design platform (and design schema).

By way of example, and referring to the example design schema discussed above, application 220 may initialise a new design by creating a new design dataset and populating it with: a unique design identifier (which may be automatically generated); dimensions data (which may be based on the size data or predefined dimensions); and an empty elements array.

At 604, application 220 selects the next action from the set of actions.

In the present embodiment, and as described above, certain actions may include a content prompt. Accordingly, at 606 application 220 determines if the selected action requires generation of a content item. In the present embodiment, if the selected action includes an image prompt generation of an image is required and processing proceeds to 608. If the selected action includes an icon prompt generation of an image is required and processing proceeds to 610. Otherwise, the selected action does not require a content item to be generated and processing proceeds to 612.

At 608, application 220 causes generation of an image based on the image prompt defined by the selected action. In the present embodiment, application 220 communicates the image prompt defined by the selected action (or data based thereon) to the image generation application 222, which processes the prompt to generate an image and returns the new image (or an identifier thereof) to application 220.

In the present embodiments, image generation application 222 is or makes use of a trained text-to-image machine learning model (or an image generation model for short). As one example, image generation application 222 may be (or make use of) a diffusion model such as a Stable Diffusion, DALL-E, or an alternative diffusion model. Alternative image generation models may be used.

Once an image has been generated, and if not already done, application 220 stores the generated image, for example in an image library (and on data storage 226). Processing then proceeds to 612.

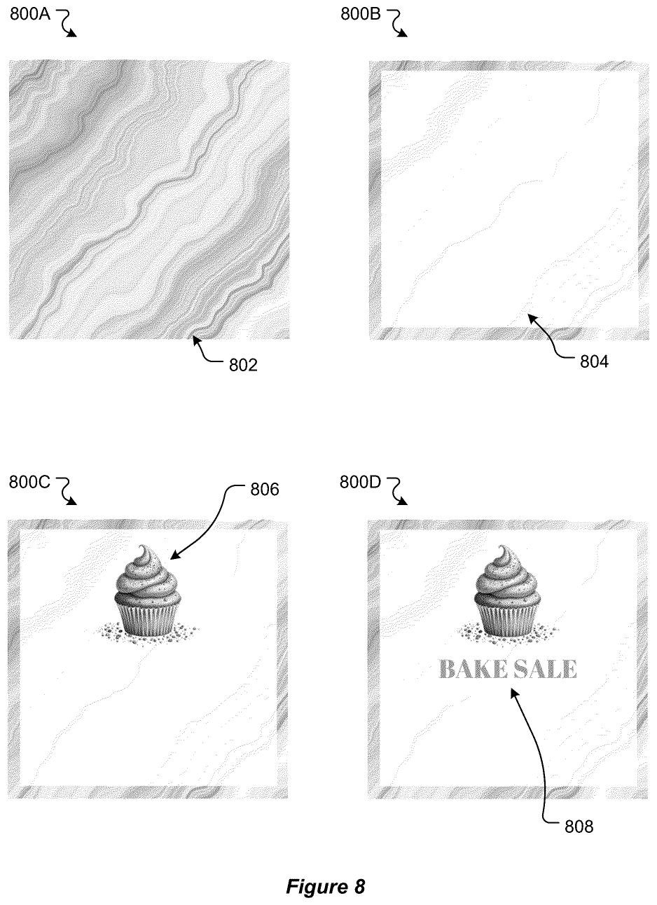

At 610, application 220 causes generation of an icon based on the icon prompt defined by the selected action. In the present embodiment, application 220 communicates the icon prompt defined by the selected action's prompt property (or data based thereon) and the colour defined by the selected action's colour property to the icon generation application 224, which processes the prompt and colour to generate and return an icon (or an identifier of an icon). Generation of an icon based on an icon prompt and colour is described in detail below with reference to FIG. 7.

Once an icon has been generated, and if not already done, application 220 stores the generated icon, for example in an icon library (and on data storage 226). Processing then proceeds to 612.

As noted above, in certain implementations other types of content prompts may be used. In this case, the type of content item that is required is determined at 606 and a relevant content item is generated at 608. For example, if a videoPrompt is encountered, that prompt is used (with an appropriate video generation application) to generate a video content item. Alternatively, if an audioPrompt is encountered, that prompt is used (with an appropriate audio generation application) to generate an audio content item.

At 612, application 220 determines element properties for a design element that is to be generated based on the selected action. Application 220 generates element properties that conform with those required (or permitted) by the design schema and based on data included in the selected action.

In some instances, application 220 is configured to determine a particular element property directly from a corresponding action property. For example, the design schema may define a “rotation” property for a first element type and the action that is being used to generate an element of that type may also define a “rotation” property. In this case, application 220 determines the element rotation property directly from the corresponding action property.

In other instances, application 220 is configured to determine or generate an element property that the selected action does not provide a value (or set of values) for. As noted above, the design schema may define certain element properties that are required in order for an element to be valid. As also noted, an action schema corresponding to a particular type of element may either: not include an action property that corresponds to a required element property (in which case it is not possible to specify a value for the required element property in an action); or may include an action property that corresponds to the required element property as an optional property (in which case it is possible to specify a value for the required element property in an action but not required).

If there are one or more undefined element properties (that is, element properties that are required by the design schema or otherwise desirable to provide values for and that the selected action does not define values for) application 220 determines each undefined element property. Application 220 may be configured to determine an undefined element property in various ways.

For certain element properties, application 220 is configured to determine a default value for the element property if a suitable value cannot be determined from the selected action. To illustrate this, consider the example “rectangle action schema” described above in which the border radius, border colour, and border width action properties are defined as being optional. If the selected action is a rectangle action and does not include values for these properties, application 220 may be configured to use default values for the corresponding element properties. For example, application 220 may be configured to: set a default value of 0 for the element border radius property; set a default value of “#000000” (corresponding to the colour black) for the element border colour property; and set a default border width value of 0 for the element border width property (resulting in no visible border).

In certain embodiments, and for certain element properties, application 220 is configured to generate a new value for the element property if a suitable value cannot be determined from the selected action. To illustrate this, consider again the example “rectangle action schema” described above and the optional border colour property. Instead of using a default border colour value if this is missing from the action, application 220 may instead generate and use a new colour value. The new colour value may be based on various data. For example, a new colour (and corresponding colour value) may be generated based on: the colour(s) of other element(s) in the design—e.g. so the new colour is complementary to that/those colour(s); a colour palette that is associated with the design or with an identifier of the user that is causing the design to be generated; and/or other data.

As discussed with reference to processing block 508 above, where an action schema defines an optional action property and a corresponding element property value will be automatically determined or generated if an action does not specify that property, information on how the corresponding element property value is determined or generated may be included in the action generation prompt.

At 614, application 220 generates a design element. The design element is generated based on any content item that has been generated (e.g. at 608 or 610 in the present embodiment); the element properties determined at 612, and the design schema (or, more specifically, the element schema for the type of element that is being generated). Examples of design elements (in accordance with the example design schema used herein) that are generated based on actions (in accordance with the example actions schema used herein) are provided above.

At 616, application 220 adds the design element generated at 614 to the design initialised at 602. In the present embodiments, and in the context of the example design schema described above, application 220 adds the element to the design by adding it to the element's array.

More specifically, and continuing with the example prompt described above (which specifies that elements will be added to a design in the depth order they are returned in) and the example design schema (where an element's position in the elements array determines its depth), application 220 adds the design element to the design by appending it to the elements array (i.e. adding it as the last element of the elements array).

At 618, application 220 determines whether there are any unprocessed actions (i.e. any actions that have not been processed to generate a corresponding design element). If so, processing proceeds to 604 to select and process the next action. Otherwise, processing proceeds to 620.

At 620, all elements for the new design have been generated and added to the design. Application 220 then finalises and returns the design. If additional data or values need to be added to the design in order to finalise it (in accordance with the design schema), application 220 does so at 620. Application 220 may also persistently store the design at 620 (e.g. by writing it to data storage 226), in which case returning the design may involve returning a reference to the stored design (e.g. the design identifier). Automatic generation of the new design is then complete.

In method 600, application 220 determines whether the generation of content items is required (at 606) and, if so, generates content items (at 608 and 610). In alternative embodiments, content item generation may be handled in a separate process (and/or by a separate application). For example, a set of actions (e.g. as generated at 510 of method 500) may be processed in a separate process to determine all actions requiring the generation of content items and to generate those content items. The generated content items (or references/pointers thereto) may then be provided during element generation.

Furthermore, in alternative implementations instead of generating content items (e.g. at 608 and 610) based on content prompts included in actions, application 220 (or an alternative application) could be configured to retrieve existing content items based on content prompts. For example, instead of generating a new content item (e.g. a new image, video, audio, or other type of content item) based on a content prompt at 608, application 220 (or an alternative application) could be configured to query an relevant content item library (e.g. an image, video, audio, or other content type library) using the content prompt and select an existing content item from that library. Similarly, instead of generating a new icon based on an icon prompt at 610, application 220 (or an alternative application) could be configured to query an icon library using the icon prompt and select an existing icon from that library.

In method 600, the actions from the set of actions are processed sequentially. In alternative embodiments, application 220 (and/or other applications) may be configured to process some or all of the actions in the set of actions in parallel. In this case, however, application 220 will be configured to perform additional processing to ensure that the design elements that are generated according to the actions are added to the design in the right depth order (e.g. in an order that corresponds to the order of the actions in the set of actions).

Turning to FIG. 7, a method 700 for generating an icon based on an icon prompt and a colour (referred to as the icon colour) will be described. Method 700 is performed to generate an icon at processing block 610 of method 600.

In the context of the present disclosure, an icon is a raster format image that includes transparency (e.g. via a transparent colour or alpha channel). By way of example, an icon may be a GIF, PNG, BMP, TIFF, JPEG 2000 or an alternative raster format image that provides a mechanism for recording pixel transparency.

The processing of method 700 is described as being performed by the icon generation application 224 (referred to as application 224 in this section). In alternative embodiments, however, the processing of method 700 could be performed by one or more alternative applications. As one example, the server application 214 could be configured to perform the processing of method 700. As another example, the client application 232 could be configured to perform the processing of method 700.

At 702, application 224 acquires a base image based on the icon prompt.

In the present embodiment, application 224 is configured to generate a new image to be used as the base image based on the icon prompt. In order to do so, application 224 communicates the icon prompt (or data based thereon) to the image generation application 222, which processes the prompt to generate an image and returns that image to application 220. This may be the same as, or similar to, image generation as described at processing block 608 of method 600.

In alternative embodiments, instead of generating a new image at 702, application 224 (or an alternative application) is configured to query an image library using the icon prompt and select an existing image from that library to be used as the base image.

The base image is a raster format image. Accordingly, the base image is defined by image data that defines the pixels of the base image. Each pixel is associated with a pixel colour (e.g. defined by a set of RGB values). Each pixel is also associated with a pixel brightness value. In the present context, brightness is a value on a scale with pure black at one end (e.g. a brightness value of 0 or 0%) and pure white at the other end (e.g. a brightness value of 255 or 100%). Pixel brightness may be calculated by using various known methods. As one example, pixel brightness may be calculated as an average (or weighted average) of a pixel's three colour channel (R, G, B) values.

At 704, and if required, the base image is processed according to a background removal process to remove any background. The background removal processing may be performed by application 224 or by an alternative application. Further, any appropriate background removal process may be used. The base image following background removal may be referred to as a background removed image.

In some implementations, the base image that is generated or retrieved at 702 may either have no background (e.g. if it is specifically generated in this way) or may already have been processed to remove any background. In this case background removal processing at 704 is not required and the base image is already a background removed image.

At 706, application 224 processes the background removed image (e.g. the base image following background removal if required or the base image itself if background removal is not required) to generate brightness frequency distribution data (referred to as the frequency distribution for convenience). The frequency distribution provides a record of all pixel brightness values that occur in the background removed image and, for each pixel brightness value, the number of pixels in the background removed image that have that brightness value. The frequency distribution will typically be a brightness histogram, but could be generated/presented in alternative ways.

At 708, application 224 processes the frequency distribution to determine a threshold brightness value. As described below, this value is used to determine a transparency value that is applied to pixels of the background-removed image.

In the present embodiments, application 224 determines the threshold brightness value to be the brightness value in the frequency distribution at a predetermined percentile. In the present embodiments, the predetermined percentile is the 20^{th} and, accordingly, the threshold brightness value is determined to be the brightness value that corresponds to the 20^{th} percentile of the frequency distribution. An alternative predetermined percentile could be used, e.g. a percentile that is: approximately the 20^{th} percentile; between the 19^{th} and 21^{st} percentiles; between the 18^{th} and 22^{nd} percentiles; between the 15^{th} and 25^{th} percentiles; between the 10^{th} and 30^{th} percentiles; or an alternative percentile.

At 710, application 224 determines a set of transparency values. In the present context, a transparency value is a value that can be associated with or applied to a pixel in order to define a transparency of that pixel. In the present embodiments, transparency values are an alpha channel values (or alpha values for short), with a value of 0 (or 0%) indicating that a pixel is fully transparent and a value of 255 (or 100%) indicating a pixel is completely opaque (i.e. no transparency). Alternative transparency values may be used to define a pixel's transparency depending, for example, on the raster file format being used.

The set of transparency values calculated at 710 includes a transparency value corresponding to each pixel brightness value in the frequency distribution (that is, each pixel brightness value that occurs in the background removed image). In the present embodiment, application 224 calculates transparency values as follows:

For each pixel brightness value in the frequency distribution that is less than the threshold pixel brightness value, application 224 determines the corresponding transparency value to be a value that, when applied to a pixel, causes that pixel to be opaque (e.g. an alpha value of 255).

For each pixel brightness value in the frequency distribution that is greater than the threshold pixel brightness value, application 224 determines the corresponding transparency value by calculating a scaled transparency value: that is, a transparency value that is scaled based on the pixel brightness value itself. Generally, scaled transparency values are calculated so that:
scaled transparency values that correspond to lower pixel brightness values are closer to transparency values that cause a pixel to be opaque; and
scaled transparency values that correspond to higher pixel brightness values are closer to transparency values that cause a pixel to be completely transparent (e.g. an alpha value of 0).

In the present embodiment, a linear scaling is used. In particular, the scaled transparency values corresponding to pixel brightnesses values that fall on and between the threshold pixel brightness value and the highest pixel brightness value are linearly scaled between a transparency value that causes a pixel to be opaque (for the pixel brightness that is equal to the threshold brightness) through to a transparency value that causes a pixel to be completely transparent (for the pixel brightness at the highest brightness end of the frequency distribution). Typically, the highest brightness pixels in the base image will be pure white pixels (e.g. brightness 255) which correspond to the background pixels of the base image that have been removed and/or other pixels of the base image that are pure white.

By way of example, frequency distribution data generated at 706 and transparency values generated at 710 may be stored in a table data structure such as the example below. Frequency distribution data and/or transparency values may, however, be stored in separate data structures (and/or in other data formats).

| | | |
|---|---|---|
| Brightness value | Frequency | Transparency value |

0
. . .
255

### Example Frequency Distribution and Transparency Values

At 712, application 224 edits the background removed image in order to generate what will be referred to an icon version thereof (or simply an icon). In the present embodiment this involves processing each pixel of the background removed image (in turn or in parallel) to apply a transparency value and a colour. More specifically: at 714, application 224 determines a selected pixel's brightness value and applies the transparency value corresponding to that brightness value (as calculated at 710) to the selected pixel; and at 716, application 224 sets the selected pixel's colour to the icon colour.

Application 224 may be configured to apply pixel transparencies and pixel colours in alternative ways. For example, if more efficient application 224 may set the colour of all pixels in one processing pass and then set pixel transparency values in a separate processing pass.

At 718, once all pixels have been edited, generation of the icon is complete. Application 224 may return the icon (i.e. the background removed image as edited) to design generation application 220 and/or may persistently store the icon (e.g. by writing it to data storage 226, in which as returning the icon may involve returning a reference to or identifier of the stored icon).

To further illustrate the features of method 500, the following provides an example design generation process that is based on a design request of “a social media post for a bake sale”. In this example, this design request results in the following (abbreviated) action generation prompt being generated at 508:

You are creating a design based on a design request.
The design request that describes the design is “a social media post for a bake sale”.
The design has a width of 1080 pixels and a height of 1080 pixels.
In order to create the design you have an API available for adding elements to the design. You
are to return a valid JSONL file that does not include anything except an ordered set of actions,
with each action on a new line. The design starts off blank and each action will result in an
element being added to the design in depth order from back to front (so the later an action appears
in the set the higher the z-index of the element that is generated based on that action). The actions
that are available via the API and their properties are as follows:
<available_actions>
[set of available action components omitted]
</available_actions>
Please take the following into account:
[design guidance components omitted]

### Example (Abbreviated) Action Generation Prompt

The set of actions that is generated at 510 based on this action generation prompt may then be as follows (noting that word wrapping has occurred):

{″actionType″:″background″, ″fill″:{″type″:″image″,″imagePrompt″:″a pink and white pattern”}
{″actionType″:″rectangle″,″position″:″x:40,y:40,w:1000,h:1000″,″fill″:{″type″:″colour″,″colour″:
″#FFFFFF″,″opacity″:0.85},″borderRadiusPercent″:5}
{″actionType″:″rectangle″,″position″:″x:340,y:100,w:400,h:400″,″fill″:{″type″:″image″,
″imagePrompt″:″watercolour style cupcake with pink frosting and sprinkles on white
background”}
{“actionType”: “text”, “position”: “x:240, y:520, w:600, h:120”, “content”: “BAKE SALE”,
“fontName”: “Abril Fatface”, “textColour”: “#FF69B4”, “effect”:{“type”: “shadow”,“colour”:
“#FFFFFF”, “blur”: 0.5, “offset”: 1, “opacity”: 1}}
{“actionType”: “text”, “position”: “x:240, y:640, w:600, h:60”, “content”: “Join us for sweet
treats & delicious delights”, “fontName”: “Montserrat”, “textColour”: “″:″#333333”,
“italic”:true}
{“actionType”: “text”, “position”: “x:240,y:720,w:600,h:100”, “content”: “Saturday, June
15th\n10 AM - 2 PM”, “fontName”: “Poppins”, “textColour”: “#333333”, “bold”:true}
{“actionType”: “text”, “position”: “x:240,y:840,w:600,h:80”, “content”: “Community
Center\n123 Main Street”, “fontName”: “Montserrat”, “textColour”: “#666666”}
{″actionType″:″icon″,″position″:″x:80,y:80,w:100,h:100″, ″iconPrompt″:″black cupcake icon on
white background″, ″colour″:″#FF69B4″}
{″actionType″:″icon″,″position″:″x:900,y:900,w:100,h:100″, ″iconPrompt″:″black whisk icon on
white background″, ″colour″:″#FF69B4″}

### Example Set of Actions

The set of actions is then used to generate a new design. This is depicted visually in FIG. 8 which shows versions (800A-800H) of the new design as elements are generated and added. Specifically: a 1080×1080 design is initialised at 602 (not depicted); the first action is processed to generate and add a background element 802 (see version 800A); the next action is processed to generate and add a rectangle element 804 with a solid colour fill (see version 800B); the next action is processed to generate and add a rectangle 806 element with an image fill (see version 800C); the next action is processed to generate and add a text element 808 (see version 800D); the next action is processed to generate and add a text element 810 (see version 800E); the next action is processed to generate and add a text element 812 (see version 800F); the next action is processed to generate and add a rectangle element 814 with an image fill (the “cupcake” icon) (see version 800G); the next action is processed to generate and add a rectangle element 816 with an image fill (the “whisk” icon) (see version 800H, the final version of the automatically generated design).

As described above, automatic generation of a design may (in some instances) involve generating a new icon. Various other scenarios exist, however, where generation of an icon as a stand-alone process may be desirable. For example, a user who is designing their own design may wish to include a new icon without having to design it themselves. As another example, a user may want to create a stand-alone icon for a new project or business.

Embodiments of the present disclosure are directed to systems and methods for generating an icon.

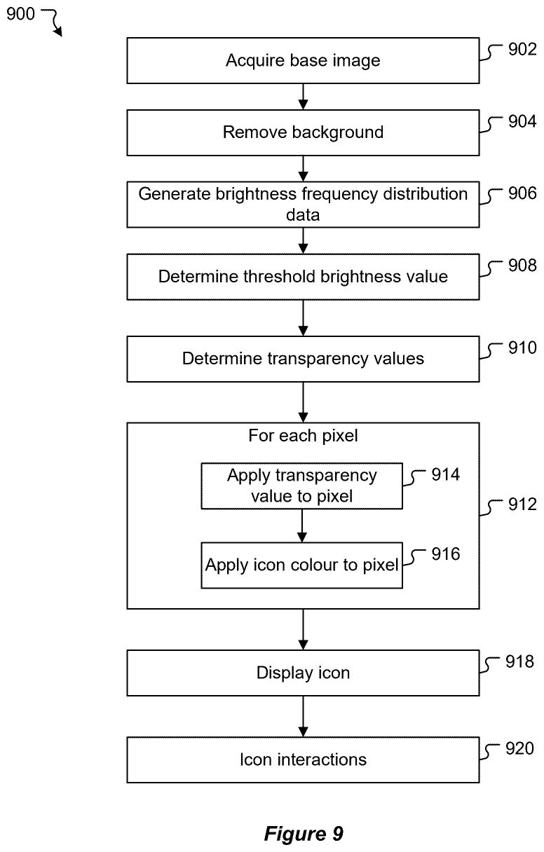

Turning to FIG. 9, a method 900 for generating an icon will be described. Certain processing performed in method 900 is similar to processing performed in method 700 (described above)—in this case reference to the corresponding processing of method 700 will be provided.

The processing of method 900 is described as being performed by the icon generation application 224 (referred to as application 224 in this section). In alternative embodiments, however, the processing of method 900 could be performed by one or more alternative applications. As one example, the server application 214 could be configured to perform the processing of method 900. As another example, the client application 232 could be configured to perform the processing of method 900.

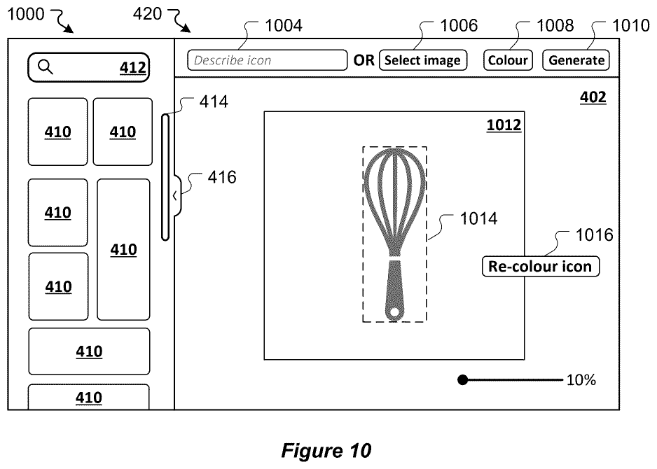

In the present embodiment, generation of an icon via method 902 is triggered by a user interacting with a user interface such as UI 1000 depicted in FIG. 10. UI 1000 is similar to UI 400 of FIG. 4, except the additional controls area 420 of UI 1000 includes a set of one or more icon generation controls. In this particular example, the icon generation controls include a text input field 1004 via which a user can enter text to describe an icon they wish to generate (referred to as the icon description). In this particular example, an image selection control 1006 is also provided via which a user can search or browse for and select an existing image that is to be used as the basis for the icon that is to be generated.

In the present embodiments, a user may select to generate an icon based on either an icon description (provided via control 1004) or via a selected image (via control 1006) (not both). Further, while the present embodiment permits a user to either describe an icon that is to be generated or select an image that an icon is to be based on it is not necessary to provide both options.

In this particular example a colour selection control 1008 is also provided which allows a user to select a colour of the icon that they wish to generate. For example, activation of the colour selection control 1008 may: cause display of a colour selection user interface which allows a user to select a colour from a set of colours and/or specify a colour value (e.g. via RGB values, a hex value, or other colour scheme values); initiate an eye eyedropper type tool that allows a user to select a colour displayed in the user interface; and/or provide other mechanisms for selecting a colour.

A generate icon control 1010 is also provided. In this example, activation of the generate icon control 1010 causes the client application to communicate relevant data (e.g. text entered into field 1004 and colour data describing any colour selected via control 1008) to application 224 (either directly or via server application 214), thus triggering generation of a new icon.

At 902, application 224 acquires a base image. This may be done in various ways.

In the present embodiments, if a user enters an icon description (e.g. via UI control 1004), application 224 generates a base image based on that icon description. To do this, application 224 (or an alternative application) generates an icon prompt that is based on the icon description provided by the user and then uses that prompt to generate the base image. Generation of the base image may be the same as (or similar to) generating an image at 608 of method 600 described above (with the image being generated based on the icon prompt).

Application 224 is configured to generate the icon prompt with a view causing the image generation application (e.g. application 222) to generate a base image that provides a good starting point for generating an icon in accordance with the processing of method 900. For example, application 224 may process the text provided by the user to identify the subject and then generate an icon prompt by adding that subject to predefined prompt text such as “a simple black <subject> on a white background”. E.g. if the if the user entered text of “a whisk icon” or the like, application 224 would identify the subject as “whisk” and generate an icon prompt of “a simple black whisk on a white background”. Alternatively, application 224 may be configured to use the exact text provided by the user as the icon prompt.

In alternative embodiments, instead of generating a new image to be the base image, application 224 (or an alternative application) may use the icon description to search for and select an existing image as the base image (e.g. from an image library).

In the present embodiments, if a user selects an image to base the icon on (e.g. via control 1006) instead of entering an icon description, application 224 uses the selected image as the base image.

At 904, and if required, application 224 removes (or causes removal of) the background of the base image acquired at 902. This involves the same (or similar) processing as described at 704 above. The base image following background removal may be referred to as a background removed image. In some instances, the base image that is generated or retrieved at 902 may either have no background (e.g. if it is specifically generated in this way) or may already have been processed to remove any background. In this case background removal processing at 904 is not required and the base image is already a background removed image.

At 906, application 224 processes the background removed image (e.g. the base image following background removal if required or the base image itself if background removal is not required) to generate brightness frequency distribution data (referred to as the frequency distribution for convenience). This involves the same (or similar) processing to that described at 706 above.

At 908, application 224 processes the frequency distribution data to determine a threshold brightness value. This involves the same (or similar) processing to that described at 708 above.

At 910, application 224 determines a set of transparency values that includes a transparency value corresponding to each pixel brightness value. This involves the same (or similar) processing to that described at 710 above.

At 912 (and 914 and 916), application 224 edits the background removed image in order to generate what will be referred to an icon version thereof (or simply an icon). This involves processing each pixel of the background removed image to apply a transparency value (which is determined based on the pixel's brightness and the set of transparency values) and the icon colour. This involves the same (or similar) processing to that described at 712 (and 714 and 716) above, noting the below description of how application 224 determines the icon colour at processing block 916.

At 916, application 224 applies the icon colour to each pixel in the background removed image. In the present embodiments, if a user has selected an icon colour (e.g. via colour selection control 1008), the application 224 uses the colour selected by the user as the icon colour. If the user has not selected a colour (or in embodiments where a colour selection control is not provided), application 224 is configured to use a predefined icon colour (in the present examples black, however an alternative colour could be used). In alternative embodiments, if an icon colour is not specified application 224 may be configured to determine an icon colour based on other data (e.g. based on the colours of other design elements that may be displayed in a UI, user preferences, or any other relevant data).

At 918, the icon generated at 912 is displayed. In the present embodiment, this may involve application 224 communicating the icon (or a design element that is generated to include the icon) to a client application such as 232 (directly or via server application 214) which then displays the icon in a user interface (e.g. UI 1000).

In the present example, the icon that is generated is added to a design element (e.g. as an image fill of a rectangle type element) and that element has been added to a new design, and client application 232 displays that new design which is then displayed by the client application (e.g. design 1012 with icon 1014). If, however, an existing design (with existing design elements) was open when the icon generation process was triggered, the new design element (with the new icon) could be added to (and displayed in) that existing design. By way of further example, the icon need not be added to a design element (or a design) and may be communicated to and displayed by client application 232 as a stand-alone icon (e.g. as a raster image that has not yet been added to any design).

Once the icon is displayed, and as generally indicated at 920, a user may (via a user interface) interact with it in various ways. By way of example, client application 232 may provide a user interface that includes a recolour icon control (such as control 1016 which may, for example, be displayed on selection of or an alternative interaction with icon 1014). On activation of a recolour icon control a colour selection user interface is displayed (e.g. as described above) allowing a user to select a colour and initiate recolouring of the icon that has been generated. On selection of a colour, the client application 232 (or an alternative client- or server-side application) recolours the icon by updating each pixel's colour value to the selected colours (but leaving the pixel transparency values as they are).

By way of further example, client application 232 may also (or alternatively) be configured to provide controls (or functionality) by which a user can: copy the icon (to a clipboard or similar) so it can be pasted elsewhere (e.g. in another design or alternative electronic document); save the icon (as a stand-alone image, a design element, or a design that includes the icon) to persistent memory (e.g. memory 310 of client system 230 and/or data storage 226 of server environment 210); share the icon; publish the icon; and/or otherwise interact with the icon.

Further examples of specific feature combinations taught within the present disclosure are set out in the following sets of numbered clauses.

Clause set A:
Clause a1. A computer implemented method including:
   receiving, via one or more user input devices, a design request, wherein the design request includes a design description that describes a design;
   processing, by one or more processing devices, the design request to generate an action generation prompt, wherein the action generation prompt includes a first prompt component that is based on the design request, a second prompt component that includes instructions to generate a set of actions, and a third prompt component that describes action schemas for one or more different types of action that are available;
   generating a set of output actions by processing the action generation prompt using a first trained machine learning model; and
   generating a new design based on the set of output actions, wherein generating the new design includes:
      processing the set of output actions to generate a corresponding set of design elements; and
      including the set of design elements in the new design.
Clause a2. The computer implemented method of clause a1, wherein
   the set of output actions includes a first output action that includes first action position data and an image prompt;
   the method further includes acquiring a first image based on the image prompt; and generating the new design includes processing the first output action to generate a first design element that is associated with:
      first design element position data that defines a position of the first design element in the new design and is based on the first action position data; and
      first design element content that is the first image.
Clause a3. The computer implemented method of clause a2, wherein acquiring the first image includes generating the first image by processing the first image prompt using a trained text-to-image machine learning model.
Clause a4. The computer implemented method of clause a2, wherein acquiring the first image includes performing an image search using the first image prompt and selecting the first image from a set of search results.
Clause a5. The computer implemented method of any one of clauses a1 to a4, wherein:
   the set of output actions includes a second output action that includes second action position data and an icon prompt;
   the method further includes generating a second image based on the icon prompt; and
   generating the new design includes processing the second output action to generate a second design element that is associated with:
      second design element position data that defines a position of the second design element in the new design and is based on the second action position data; and
      second design element content that is the second image.
Clause a6. The computer implemented method of clause a5, wherein:
   the second output action includes second action colour data; and
   the second image is generated based on the icon prompt and the second action colour data.
Clause a7. The computer implemented method of clause a5 or clause a6, wherein generating the second image includes:
   acquiring, based on the icon prompt, a background removed image, wherein the background removed image is defined by image data that includes a plurality of pixels and each pixel is associated with a pixel brightness value;
   processing the image data to generate brightness frequency distribution data that describes a number of pixels that are associated with each different pixel brightness value;
   determining, based on the brightness frequency distribution data, a threshold brightness value;
   determining, by the one or more processing devices, a set of transparency values, wherein the set of transparency values includes a transparency value corresponding to each different pixel brightness value; and
   editing the plurality of pixels, wherein editing the plurality of pixels includes editing a first pixel of the plurality of pixels by:
      determining a first transparency value for the first pixel, wherein the first transparency value is the transparency value from the set of transparency values that corresponds to the brightness value associated with the first pixel;
      applying the first transparency value to the first pixel; and
      applying an icon colour to the first pixel.
Clause a8. The computer implemented method of clause a7 when dependent on clause a6, wherein the icon colour is based on the second action colour data.
Clause a9. The computer implemented method of any one of clauses a1 to a8, wherein:
   the set of output actions includes a third output action that includes third action position data and third action colour data; and
   generating the new design includes processing the third output action to generate a third design element that is associated with:
   third design element position data that defines a position of the third design element in the new design and is based on the third action position data; and
   third design element content that is a solid colour fill having a colour that is based on the third action colour data.
Clause a10. The computer implemented method of any one of clauses a1 to a9, wherein:
   the set of output actions includes a fourth output action that includes fourth action position data and colour gradient data; and
   generating the new design includes processing the fourth output action to generate a fourth design element that is associated with:
      fourth design element position data that defines a position of the fourth design element in the new design and is based on the fourth action position data; and
      fourth design element content that is a gradient colour fill having a colour gradient that is based on the colour gradient data.
Clause a11. The computer implemented method of any one of clauses a1 to a10, wherein:
   the set of output actions includes a fifth output action that includes fifth action position data and text data defining text; and
   generating the new design includes processing the fifth output action to generate a fifth design element that has:
   fifth design element position data that defines a position of the fourth design element in the new design and is based on the fifth action position data; and
   fifth design element content that includes the text defined by the text data.
Clause a12. The computer implemented method of clause a11, wherein:
   the fifth output action includes fifth action text format data defining one or more format properties for the text defined by the text data; and
   the fifth design element has fifth element text format data that is based on the fifth action text format data.
Clause a13. The computer implemented method of any one of clauses a1 to a12, wherein:
   the set of output actions is associated with an action order; and
   including the set of design elements in the new design includes adding the design elements to the new design in a depth order that is based on the action order.
Clause a14. The computer implemented method of any one of clauses a1 to a13, wherein:
   the action schemas described by the third prompt component define API request formats; and
   generating the new design includes including the set of output actions in one or more API requests.
Clause a15. The computer implemented method of any one of clauses a1 to a14, wherein the third prompt component further includes one or more action usage components, wherein each action usage component describes a particular property of a particular action schema.
Clause a16. The computer implemented method of any one of clauses a1 to a15, wherein:
   the action generation prompt includes a design size component that describes a design size; and
   generating the new design includes generating the new design to have the design size.
Clause a17. The computer implemented method of any one of clauses a1 to a16, wherein the action generation prompt further includes one or more design guidance components, wherein each design guidance component provides guidance for generating the set of actions.
Clause a18. The computer implemented method of any one of clauses a1 to a17, further including outputting the new design by one or more of: displaying the new design on a display device; saving the new design to a computer readable storage device; attaching the new design to an electronic communication; uploading the new design to a remote server; and printing the new design.
Clause a19. The computer implemented method of clause a5, wherein the second image is generated by a method according to any one of clauses b1 to b13:

Clause set B:
Clause b1. A computer implemented method including:
   accessing, by one or more processing devices, a background removed image, wherein the background removed image is defined by image data that includes a plurality of pixels and each pixel is associated with a pixel brightness value;
   processing the image data to generate brightness frequency distribution data that describes a number of pixels that are associated with each different pixel brightness value;
   determining, based on the brightness frequency distribution data, a threshold brightness value;
   determining, by the one or more processing devices, a set of transparency values, wherein the set of transparency values includes a transparency value corresponding to each different pixel brightness value; and
   editing the plurality of pixels, wherein editing the plurality of pixels includes editing a first pixel of the plurality of pixels by:
      determining a first transparency value for the first pixel, wherein the first transparency value is the transparency value from the set of transparency values that corresponds to the brightness value associated with the first pixel;
      applying the first transparency value to the first pixel; and
      applying a first icon colour to the first pixel.
Clause b2. The computer implemented method of clause b1, wherein determining the set of transparency values includes determining a first transparency value for all pixel brightness values that fall below the threshold brightness value, and wherein the first transparency value is a value that, when applied to a pixel, causes a pixel to be opaque or substantially opaque.
Clause b3. The computer implemented method of clause b2, wherein determining the set of transparency values includes calculating a scaled transparency value corresponding to each pixel brightness value that is equal to or above the threshold brightness value.
Clause b4. The computer implemented method of clause b3, wherein each scaled transparency value is:
   a transparency value that is between the first transparency value and a second transparency value that, when applied to a pixel, causes that pixel to be transparent or substantially transparent; and
   calculated based on the pixel brightness value that the scaled transparency value corresponds to.
Clause b5. The computer implemented method of clause b4, wherein:
   a first pixel brightness value is less than a second pixel brightness value;
   calculating the scaled transparency values includes calculating a first scaled transparency value that corresponds to the first pixel brightness value and calculating a second scaled transparency value that corresponds to the second pixel brightness value; and
   the first scaled transparency value is closer to the first transparency value than the second transparency value.
Clause b6. The computer implemented method of clause b5, wherein the scaled transparency values are linearly scaled between the first transparency value and the second transparency value.
Clause b7. The computer implemented method of any one of clauses b1 to b6, wherein the threshold brightness value is a brightness value that is at a predefined percentile in the frequency distribution.
Clause b8. The computer implemented method of clause 7, wherein the predefined percentile is between the 10^{th} and 30^{th} percentiles.
Clause b9. The computer implemented method of any one of clauses b1 to b8, wherein editing the plurality of pixels includes applying the first icon colour to all pixels.
Clause b10. The computer implemented method of any one of clauses b1 to b9, wherein the first icon colour is a predefined colour.
Clause b11. The computer implemented method of any one of clauses b1 to b9, wherein the first icon colour is determined based on a first colour selection user input.
Clause b12. The computer implemented method of any one of clauses b1 to b11, further including generating the image data by:
   acquiring an initial image; and
   processing the initial image according to a background removal process.
Clause b13. The computer implemented method of clause b12, wherein acquiring the initial image includes:
   receiving one or more first user inputs defining an icon description;
   generating an image prompt based on the icon description; and
   generating the initial image by processing the image prompt using a trained text-to-image machine learning model.
Clause b14. The computer implemented method of any one of clauses b1 to b13, further including performing a recolouring process by applying a second icon colour to all pixels.
Clause b15. The computer implemented method of clause b14, wherein the second icon colour is determined based on a second colour selection user input.
Clause b16. The computer implemented method of any one of clauses b1 to b15, wherein after editing the plurality of pixels the method further includes outputting the image defined by the image data by one or more of: displaying the image on a display device; adding the image to a design; saving the image to a computer readable storage device; attaching the image to an electronic communication; uploading the image to a remote server; and printing the image.

Clause set C:
Clause c1. A computer processing system including:
   one or more processing devices; and
   one or more non-transitory computer readable storage devices storing instructions, which when executed by the one or more processing devices, cause the one or more processing devices to perform a method according to any one of clauses a1 to a19; and/or any one of clauses b1 to b16.
Clause c.2. One or more non-transitory computer readable storage devices storing instructions, which, when executed by one or more processing devices, cause the one or more processing devices to perform a method according to any one of clauses a1 to a19; and/or any one of clauses b1 to b16.

In the embodiments described above, processing is described as being performed by specific applications. Variations are possible, and generally speaking an operation that is described as being performed by one particular application could be performed by an alternative application.

The flowcharts illustrated in the figures and described above define processing blocks in particular orders to explain various features. In some cases, the processing blocks as described and illustrated may be able to be performed in a different order to that shown/described (or in parallel). Furthermore, in some cases the operations of one or more processing blocks may be combined into a single processing block, a single processing block may be divided into multiple separate processing blocks, and/or the function(s) achieved by one or more of the described/illustrated processing blocks may be achieved by alternative processing to that described.

In the above description, certain operations and features are explicitly described as being optional. This should not be interpreted as indicating that if an operation or feature is not explicitly described as being optional it should be considered essential. Even if an operation or feature is not explicitly described as being optional it may still be optional.

The present disclosure provides various user interface examples. It will be appreciated that alternative user interfaces are possible. Such alternative user interfaces may provide the same or similar user interface features to those described and/or illustrated in different ways, provide additional user interface features to those described and/or illustrated, or omit certain user interface features that have been described and/or illustrated.

In some instances, the present disclosure and/or claims use the terms “first,” “second,” etc. to identify and distinguish between features. When used in this way, these terms are not used in an ordinal sense and are not intended to imply any particular order. For example, unless clearly required otherwise by context a first feature could equally be referred to a second feature without departing from the scope of the described examples. Furthermore, when terms such as first and second are used to differentiate between features a second feature could exist without a first feature or a second feature could occur or be ordered before a first feature.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

It will be understood that the embodiments disclosed and defined in this specification extend to alternative combinations of two or more of the individual features mentioned in or evident from the text, drawings, or clauses. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

1. A computer implemented method including:
receiving, via one or more user input devices, a design request, wherein the design request includes a design description that describes a design;
processing, by one or more processing devices, the design request to generate an action generation prompt, wherein the action generation prompt includes a first prompt component that is based on the design request, a second prompt component that includes instructions to generate a set of actions, and a third prompt component that describes action schemas for one or more different types of action that are available;
generating a set of output actions by processing the action generation prompt using a first trained machine learning model; and
generating a new design based on the set of output actions, wherein generating the new design includes:
processing the set of output actions to generate a corresponding set of design elements; and
including the set of design elements in the new design.

2. The computer implemented method of claim 1, wherein
the set of output actions includes a first output action that includes first action position data and an image prompt;
the method further includes acquiring a first image based on the image prompt; and
generating the new design includes processing the first output action to generate a first design element that is associated with:
first design element position data that defines a position of the first design element in the new design and is based on the first action position data; and
first design element content that is the first image.

3. The computer implemented method of claim 2, wherein acquiring the first image includes generating the first image by processing the first image prompt using a trained text-to-image machine learning model.

4. The computer implemented method of claim 1, wherein:
the set of output actions includes a second output action that includes second action position data and an icon prompt;
the method further includes generating a second image based on the icon prompt; and
generating the new design includes processing the second output action to generate a second design element that is associated with:
second design element position data that defines a position of the second design element in the new design and is based on the second action position data; and
second design element content that is the second image.

5. The computer implemented method of claim 4, wherein generating the second image includes:
acquiring, based on the icon prompt, a background removed image, wherein the background removed image is defined by image data that includes a plurality of pixels and each pixel is associated with a pixel brightness value;
processing the image data to generate brightness frequency distribution data that describes a number of pixels that are associated with each different pixel brightness value;
determining, based on the brightness frequency distribution data, a threshold brightness value;
determining, by the one or more processing devices, a set of transparency values, wherein the set of transparency values includes a transparency value corresponding to each different pixel brightness value; and
editing the plurality of pixels, wherein editing the plurality of pixels includes editing a first pixel of the plurality of pixels by:
determining a first transparency value for the first pixel, wherein the first transparency value is the transparency value from the set of transparency values that corresponds to the brightness value associated with the first pixel;
applying the first transparency value to the first pixel; and
applying an icon colour to the first pixel.

6. The computer implemented method of claim 1, wherein:
the set of output actions includes a third output action that includes third action position data and third action colour data; and
generating the new design includes processing the third output action to generate a third design element that is associated with:
third design element position data that defines a position of the third design element in the new design and is based on the third action position data; and
third design element content that is a solid colour fill having a colour that is based on the third action colour data.

7. The computer implemented method claim 1, wherein:
the set of output actions includes a fifth output action that includes fifth action position data and text data defining text; and
generating the new design includes processing the fifth output action to generate a fifth design element that has:
fifth design element position data that defines a position of the fourth design element in the new design and is based on the fifth action position data; and
fifth design element content that includes the text defined by the text data.

8. The computer implemented method of claim 1, wherein:
the set of output actions is associated with an action order; and
including the set of design elements in the new design includes adding the design elements to the new design in a depth order that is based on the action order.

9. The computer implemented method of claim 1, wherein:
the action schemas described by the third prompt component define API request formats; and
generating the new design includes including the set of output actions in one or more API requests.

10. The computer implemented method of claim 1, further including outputting the new design by one or more of: displaying the new design on a display device; saving the new design to a computer readable storage device; attaching the new design to an electronic communication;
uploading the new design to a remote server; and printing the new design.

11. A computer processing system including:
one or more processing devices;
one or more user input devices; and
one or more non-transitory storage devices storing instructions, which when executed by the one or more processing devices, cause the one or more processing devices to perform a method including:
receiving, via the one or more user input devices, a design request, wherein the design request includes a design description that describes a design;
processing the design request to generate an action generation prompt, wherein the action generation prompt includes a first prompt component that is based on the design request, a second prompt component that includes instructions to generate a set of actions, and a third prompt component that describes action schemas for one or more different types of action that are available;
generating a set of output actions by processing the action generation prompt using a first trained machine learning model; and
generating a new design based on the set of output actions, wherein generating the new design includes:
processing the set of output actions to generate a corresponding set of design elements; and
including the set of design elements in the new design.

12. The computer processing system of claim 11, wherein
the set of output actions includes a first output action that includes first action position data and an image prompt;
the method further includes acquiring a first image based on the image prompt; and
generating the new design includes processing the first output action to generate a first design element that is associated with:
first design element position data that defines a position of the first design element in the new design and is based on the first action position data; and
first design element content that is the first image.

13. The computer processing system of claim 12, wherein acquiring the first image includes generating the first image by processing the first image prompt using a trained text-to-image machine learning model.

14. The computer processing system of claim 11, wherein:
the set of output actions includes a second output action that includes second action position data and an icon prompt;
the method further includes generating a second image based on the icon prompt; and
generating the new design includes processing the second output action to generate a second design element that is associated with:
second design element position data that defines a position of the second design element in the new design and is based on the second action position data; and
second design element content that is the second image.

15. The computer processing system of claim 14, wherein generating the second image includes:
acquiring, based on the icon prompt, a background removed image, wherein the background removed image is defined by image data that includes a plurality of pixels and each pixel is associated with a pixel brightness value;
processing the image data to generate brightness frequency distribution data that describes a number of pixels that are associated with each different pixel brightness value;
determining, based on the brightness frequency distribution data, a threshold brightness value;
determining, by the one or more processing devices, a set of transparency values, wherein the set of transparency values includes a transparency value corresponding to each different pixel brightness value; and
editing the plurality of pixels, wherein editing the plurality of pixels includes editing a first pixel of the plurality of pixels by:
determining a first transparency value for the first pixel, wherein the first transparency value is the transparency value from the set of transparency values that corresponds to the brightness value associated with the first pixel;
applying the first transparency value to the first pixel; and
applying an icon colour to the first pixel.

16. The computer processing system of claim 11, wherein:
the set of output actions includes a third output action that includes third action position data and third action colour data; and
generating the new design includes processing the third output action to generate a third design element that is associated with:
third design element position data that defines a position of the third design element in the new design and is based on the third action position data; and
third design element content that is a solid colour fill having a colour that is based on the third action colour data.

17. The computer processing system claim 11, wherein:
the set of output actions includes a fifth output action that includes fifth action position data and text data defining text; and
generating the new design includes processing the fifth output action to generate a fifth design element that has:
fifth design element position data that defines a position of the fourth design element in the new design and is based on the fifth action position data; and
fifth design element content that includes the text defined by the text data.

18. The computer processing system of claim 11, wherein:
the set of output actions is associated with an action order; and
including the set of design elements in the new design includes adding the design elements to the new design in a depth order that is based on the action order.

19. The computer processing system of claim 11, wherein:
the action schemas described by the third prompt component define API request formats; and
generating the new design includes including the set of output actions in one or more API requests.

20. One or more non-transitory storage devices storing instructions that are executable by one or more processing devices to cause the one or more processing devices to perform a method including:
receiving, via one or more user input devices, a design request, wherein the design request includes a design description that describes a design;
processing the design request to generate an action generation prompt, wherein the action generation prompt includes a first prompt component that is based on the design request, a second prompt component that includes instructions to generate a set of actions, and a third prompt component that describes action schemas for one or more different types of action that are available;
generating a set of output actions by processing the action generation prompt using a first trained machine learning model; and
generating a new design based on the set of output actions, wherein generating the new design includes:
processing the set of output actions to generate a corresponding set of design elements; and
including the set of design elements in the new design.
